(19) United States
(12) Patent Application Publication
(10) Pub. No.: US 2003/0002056 A1
(43) Pub. Date: Jan. 2, 2003

(54) Printing apparatus and pre-printing information estimating method

(75) Inventors: Takehito Yamaguchi, Osaka (JP); Yuji Okada, Tokyo (JP); Kenji Hisatomi, Osaka (JP); Shigeki Matsunaga, Osaka (JP)

Correspondence Address: GREENBLUM & BERNSTEIN, P.L.C., 1941 ROLAND CLARKE PLACE, RESTON, VA, 20191, US

(73) Assignee: Matsushita Electric Industrial Co., Ltd., Osaka (JP)

(21) Appl. No.: 10/151,704

(22) Filed: May 21, 2002

(30) Foreign Application Priority Data
May 22, 2001 (JP) JP 2001-153253

(51) Int. Cl. B41J 1/00; G06F 15/00

(52) U.S. Cl. 358/1.2; 358/1.15

(57) ABSTRACT

A print image expansion section 209 creates print image data from XML source and font data, and outputs this print image data to an output switching section 210. The print image expansion section 209 also outputs size information for the created print image data to a conversion ratio calculation section 214. The conversion ratio calculation section 214 calculates a conversion ratio indicating the size ratio for converting print image data to preview data based on preview screen information and printing condition information, and outputs this conversion ratio to an image conversion section 211. The image conversion section 211 converts the print image data to preview data, and outputs this preview data to an interface section 201 via a buffer 212. The conversion ratio calculated by the conversion ratio calculation section 214 is used as the ratio for converting the print image data to preview data.

### BACKGROUND OF THE INVENTION

1. Field of the Invention

The present invention relates to a printing apparatus and pre-printing information estimation method, and more particularly to a printing apparatus and pre-printing information estimation method for printing content represented by means of a markup language stipulated by XML (extensible Markup Language).

2. Description of the Related Art

Recently, digitalization of broadcast data has been making rapid progress in the field of broadcasting technology. Advantages of digitalizing broadcast data include the fact that digital data can use bands more efficiently than analog data, and a high degree of affinity with data other than video and audio.

One kind of broadcast content using digital data is content represented by means of XML. XML is a Meta-language that stipulates a markup language with a special feature of enabling tags to be defined uniquely. With BML (Broadcast markup Language), an XML application for digital broadcasting, various kinds of information can be incorporated as digital data, such as program linkage type information: for example, recipe information for a cooking program or reference information for a quiz program.

In XML, including BML, style information relating to the representation style is written as a style sheet. In XML, a plurality of style sheets can be applied to one document written in XML language format (hereinafter referred to as “XML instance”). For example, it is possible to apply a display style sheet and a print style sheet individually for one XML instance according to the output destination conditions or purpose, and make full use of the output performance of a display apparatus that displays on a cathode ray tube, liquid crystal display, etc., and a printing apparatus, according to differences in output conditions.

When style sheets with different layouts are used for a display style sheet and print style sheet, the layouts of displayed contents and contents to be printed are different, and it is therefore difficult to confirm print contents from the displayed contents.

However, with a conventional apparatus there is a problem in that, when layout information differs for a display style sheet and print style sheet, the print layout cannot be confirmed (on a display apparatus or the like) until printed from a printing apparatus.

Also, with a conventional apparatus there is a problem in that the time necessary for printing cannot be known. Furthermore, with a conventional apparatus there is a problem in that the cost necessary for printing cannot be known.

### SUMMARY OF THE INVENTION

It is an object of the present invention to provide a printing apparatus and pre-printing information estimation method that make it possible to provide print image information and print job results information prior to printing.

This object is achieved by seeking information that determines print execution results before executing printing when performing printing with a printing apparatus from a receiving apparatus (client apparatus), and transmitting that information to, and displaying that information on, the receiving apparatus.

A client apparatus here includes an apparatus that receives broadcast content transmitted from a broadcasting station, as well as a client apparatus that transmits a data request to a server and receives data in a general server-client system.

### BRIEF DESCRIPTION OF THE DRAWINGS

The above and other objects and features of the invention will appear more fully hereinafter from a consideration of the following description of the preferred embodiments taken in connection with the accompanying drawings wherein one example is illustrated by way of example, in which:

FIG. 1 is a block diagram showing the configuration of a receiving apparatus and printing apparatus according to Embodiment 1 of the present invention;

FIG. 2 is a sequence diagram showing an example of signal exchange between a receiving apparatus and printing apparatus;

FIG. 3 is a block diagram showing the configuration of a receiving apparatus according to Embodiment 1 of the present invention;

FIG. 4 is a block diagram showing the configuration of a printing apparatus according to Embodiment 1 of the present invention;

FIG. 5 is a flowchart showing an example of the operation of a printing apparatus of the above embodiment;

FIG. 6 is a drawing showing examples of print image data and preview data;

FIG. 7 is a flowchart showing conversion ratio calculation;

FIG. 8 is a drawing showing a sample preview according to a combination of print image data and preview area;

FIG. 9 is a drawing showing a sample preview according to a combination of print image data and preview area;

FIG. 10 is a drawing showing a sample preview according to a combination of print image data and preview area;

FIG. 11 is a drawing showing a sample preview according to a combination of print image data and preview area;

FIG. 12 is a drawing showing an example of receiving apparatus display;

FIG. 13 is a drawing showing an example of receiving apparatus display;

FIG. 14 is a drawing showing an example of receiving apparatus display;

FIG. 15 is a drawing showing an example of receiving apparatus display;

FIG. 16 is a block diagram showing the configuration of a printing apparatus according to Embodiment 2 of the present invention;

FIG. 17 is a sequence diagram showing an example of signal exchange between a receiving apparatus and printing apparatus;

FIG. 18 is a block diagram showing the configuration of a printing apparatus according to Embodiment 3 of the present invention;

FIG. 19 is a block diagram showing the configuration of a printing apparatus according to Embodiment 4 of the present invention;

FIG. 20 is a block diagram showing the configuration of a printing apparatus according to Embodiment 5 of the present invention;

FIG. 21 is a block diagram showing the configuration of a printing apparatus according to Embodiment 6 of the present invention;

FIG. 22(A) is a conceptual diagram showing displayable page calculation;

FIG. 22(B) is a conceptual diagram showing displayable page calculation;

FIG. 23 is a block diagram showing the configuration of a printing apparatus according to Embodiment 7 of the present invention;

FIG. 24 is a block diagram showing the configuration of a printing apparatus according to Embodiment 8 of the present invention;

FIG. 25 is a flowchart showing an example of the operation of a printing apparatus of the above embodiment;

FIG. 26 is a block diagram showing the configuration of a printing apparatus according to Embodiment 9 of the present invention;

FIG. 27 is a flowchart showing an example of the operation of a printing apparatus of the above embodiment;

FIG. 28 is a drawing showing a configuration of a receiving apparatus and printing apparatus according to Embodiment 10 of the present invention;

FIG. 29 is a sequence diagram showing an example of signal exchange between a receiving apparatus and printing apparatus;

FIG. 30 is a block diagram showing the configuration of a printing apparatus according to Embodiment 10 of the present invention;

FIG. 31 is a flowchart showing an example of the operation of a printing apparatus of the above embodiment;

FIG. 32 is a flowchart showing an example of the operation of a printing apparatus of the above embodiment;

FIG. 33 is a flowchart showing an example of the operation of a printing apparatus of the above embodiment;

FIG. 34 is a flowchart showing an example of the operation of a printing apparatus of the above embodiment;

FIG. 35 is a drawing showing a sample print layout;

FIG. 36 is a flowchart showing an example of the operation of a printing apparatus of the above embodiment;

FIG. 37 is a block diagram showing the configuration of a printing apparatus according to Embodiment 11 of the present invention;

FIG. 38 is a sequence diagram showing an example of signal exchange between a receiving apparatus and printing apparatus;

FIG. 39 is a block diagram showing the configuration of a printing apparatus according to Embodiment 12 of the present invention;

FIG. 40 is a drawing showing the configuration of a receiving apparatus and printing apparatus according to Embodiment 13 of the present invention;

FIG. 41 is a sequence diagram showing an example of signal exchange between a receiving apparatus and printing apparatus;

FIG. 42 is a block diagram showing the configuration of a printing apparatus according to Embodiment 13 of the present invention;

FIG. 43 is a flowchart showing an example of the operation of a printing apparatus of the above embodiment;

FIG. 44 is a flowchart showing an example of the operation of a printing apparatus of the above embodiment;

FIG. 45 is a flowchart showing an example of the operation of a printing apparatus of the above embodiment;

FIG. 46 is a block diagram showing the configuration of a printing apparatus according to Embodiment 14 of the present invention;

FIG. 47 is a sequence diagram showing an example of signal exchange between a receiving apparatus and printing apparatus; and

FIG. 48 is a block diagram showing the configuration of a printing apparatus according to Embodiment 15 of the present invention.

### DETAILED DESCRIPTION OF THE PREFERRED EMBODIMENTS

With reference now to the accompanying drawings, embodiments of the present invention will be explained in detail below.

[Print Preview Image Creation]

The gist of the present invention is to convert print image data taking account of print results and differences in output to a display apparatus based on the display capability of a receiving apparatus (client apparatus), create preview image data (hereinafter referred to simply as “preview data”), transmit this preview data to a receiving apparatus, and display this preview data in the receiving apparatus.

(Embodiment 1)

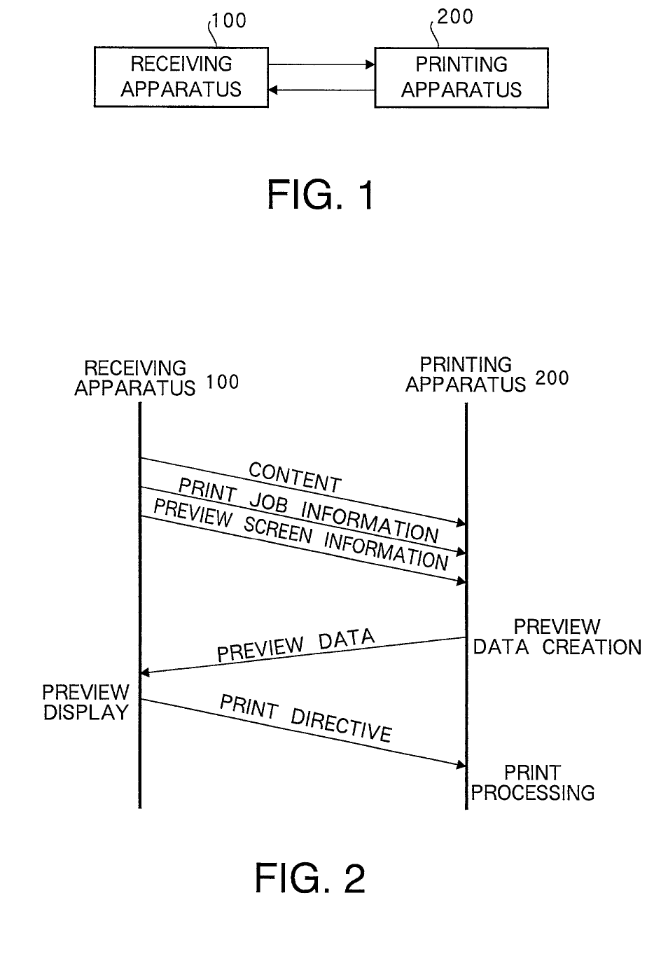

FIG. 1 is a block diagram showing the configuration of a receiving apparatus and printing apparatus according to Embodiment 1 of the present invention.

In FIG. 1, a receiving apparatus 100 receives a digital broadcast or similar signal and displays broadcast contents. When broadcast contents are to be printed, the receiving apparatus 100 revieves a print directive and outputs data necessary for printing to a printing apparatus 200, and the printing apparatus 200 creates print contents preview image data and outputs this data to the receiving apparatus 100.

When a print preview is ordered by the receiving apparatus 100, print image data is displayed, and print contents confirmation and a print directive are prompted. Then the receiving apparatus 100 outputs the input print directive to the printing apparatus 200, and the printing apparatus 200 prints print contents corresponding to the preview image in accordance with the directive.

The communication procedure between the receiving apparatus 100 and printing apparatus 200 will now be described. FIG. 2 is a sequence diagram showing an example of signal exchange between the receiving apparatus 100 and printing apparatus 200. In FIG. 2, the communication procedure is described for a case where, when the receiving apparatus 100 prints received contents, the print results are displayed beforehand in the receiving apparatus 100 and printing is performed after the print contents have been confirmed.

In FIG. 2, the receiving apparatus 100 outputs content to be printed-for example, XML content-from received broadcast contents to the printing apparatus 200. Here, XML content includes an XML instance and style sheet.

Then the receiving apparatus 100 outputs print job information indicating conditions necessary for printing, such as the printing paper size, resolution, and printing direction, for example, to the printing apparatus 200. The receiving apparatus 100 then outputs preview information comprising conditions for displaying preview data to the printing apparatus 200. Here, preview data is an image when print output is displayed on a screen.

The printing apparatus 200 creates preview data from the XML content, print job information, and preview information, and outputs this preview data to the receiving apparatus 100.

The receiving apparatus 100 displays the preview data, and prompts input as to whether or not printing is to be performed. When a directive to perform printing is inputted, the receiving apparatus 100 outputs a print directive to the printing apparatus 200, and the printing apparatus 200 prints XML content in accordance with the directive. When XML content and print job information are not stored in the printing apparatus 200, the receiving apparatus 100 may again output XML content and print job information to the printing apparatus 200 together with a print directive.

The receiving apparatus 100 and printing apparatus 200 will now be described in detail. First, a detailed description of the receiving apparatus 100 will be given.

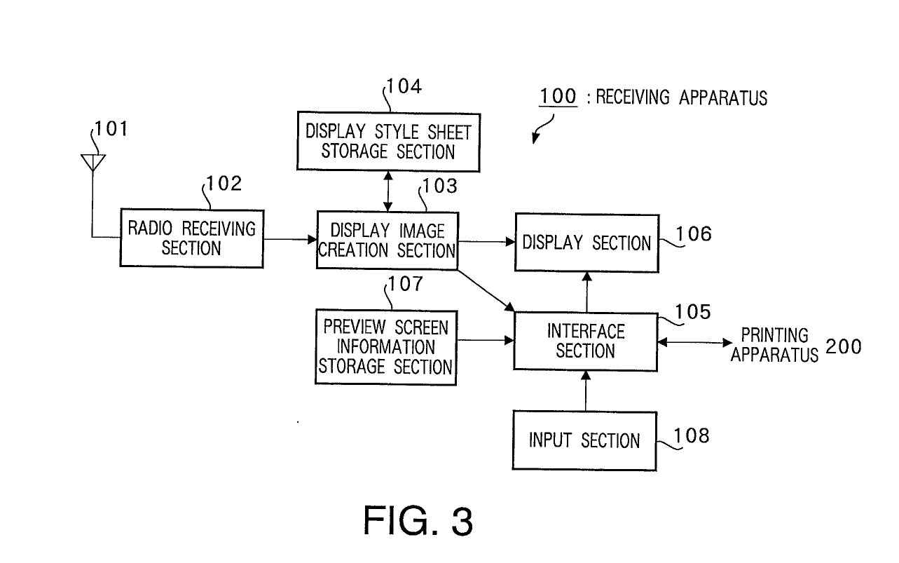

FIG. 3 is a block diagram showing the configuration of a receiving apparatus according to Embodiment 1 of the present invention. In FIG. 3, the receiving apparatus 100 mainly comprises an antenna 101, radio receiving section 102, display image creation section 103, display style sheet storage section 104, interface section 105, display section 106, preview screen information storage section 107, and input section 108.

The antenna 101 receives a radio signal and outputs that signal to the radio receiving section 102. The radio receiving section 102 performs signal processing such as frequency conversion, demodulation, and decoding on the received radio signal, and outputs the obtained received signal to the display image creation section 103.

The display image creation section 103 performs parsing processing on a received XML instance by means of a parsing (syntax analysis) program called an “XML Parser”. That is to say, the display image creation section 103 parses a DTD (Document Type Definition) document and XML document constituting an XML instance and creates a document object. This document object is a structured document in which a tree structure is formed in accordance with tags in the original XML document.

Then, using a style sheet in the document object, the display image creation section 103 creates XML source containing layout information, creates display image data from the XML source, and outputs this display image data to the display section 106.

The display style sheet storage section 104 stores the style sheet, and outputs the style sheet to the display image creation section 103.

The interface section 105 outputs an XML instance, print preview or print directive, and preview information to the printing apparatus 200. The interface section 105 also outputs display image data input from the printing apparatus 200 to the display section 106.

The display section 106 displays display image data on a cathode ray tube, liquid crystal display, or the like. The preview screen information storage section 107 stores preview information of display section 106, and outputs this preview information to the interface section 105.

The input section 108 receives a print preview or print directive, and outputs the print preview or print directive to the interface section 105.

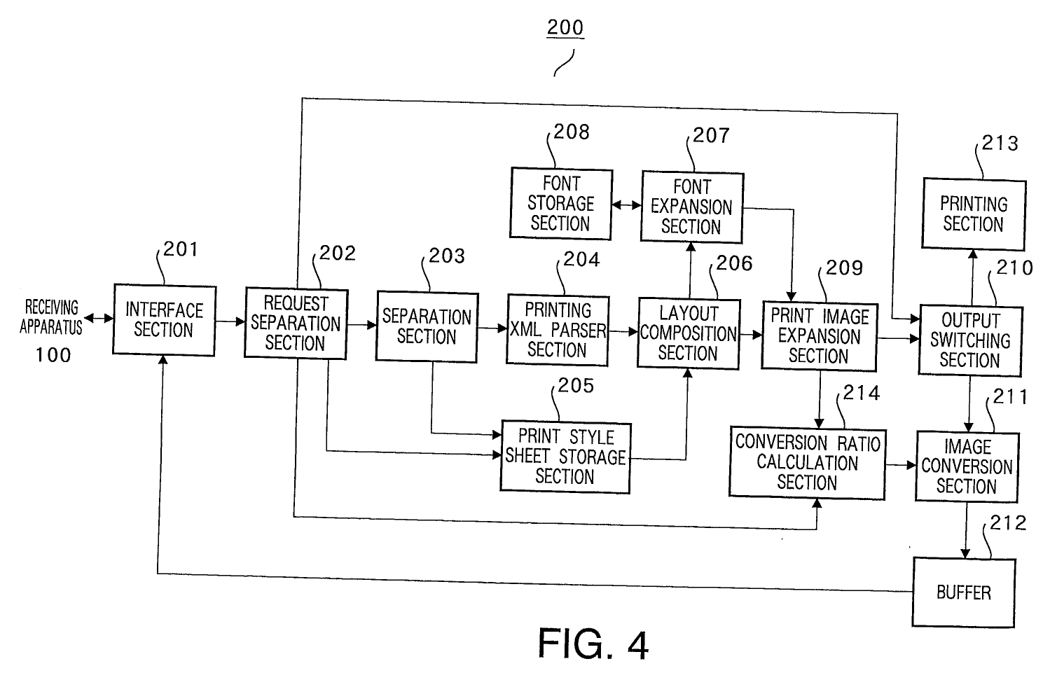

Next, a detailed description of the printing apparatus 200 will be given. FIG. 4 is a block diagram showing the configuration of a printing apparatus according to Embodiment 1 of the present invention.

In FIG. 4, the printing apparatus 200 mainly comprises an interface section 201, request separation section 202, separation section 203, printing XML parser section 204, print style sheet storage section 205, layout composition section 206, font expansion section 207, font storage section 208, print image expansion section 209, output switching section 210, image conversion section 211, buffer 212, printing section 213, and conversion ratio calculation section 214.

The interface section 201 receives print data transmitted from the receiving apparatus 100 and outputs that print data to the request separation section 202. The interface section 201 also transmits preview data output from the buffer 212, described later herein, to the receiving apparatus 100.

The request separation section 202 extracts a print preview or print directive from the print data, and outputs the extracted print preview or print directive to the print style sheet storage section 205 and output switching section 210. The request separation section 202 also extracts a print preview directive and preview information from the print data and outputs these to the conversion ratio calculation section 214. In addition, the request separation section 202 outputs the print data to the separation section 203.

The separation section 203 extracts an XML instance from the print data and outputs this XML instance to the printing XML parser section 204. The separation section 203 also extracts a print style sheet from the print data and outputs this print style sheet to the print style sheet storage section 205.

The printing XML parsersection204 performs parsing processing on the received XML instance with an XML parser, parses a DTD document and XML document and creates a document object, which it outputs to the layout composition section 206. This document object is a structured document in which a tree structure is formed in accordance with tags in the original XML document.

The print style sheet storage section 205 stores a print style sheet, and outputs it to the layout composition section 206.

Using the document object and print style sheet expanded by the printing XML parser section204, the layout composition section 206 creates XML source and outputs this XML source to the print image expansion section 209. The layout composition section 206 also gives a directive for a font expansion necessary for creation of print image data to the font expansion section 207.

The font expansion section 207 refers the font storage section 208 in accordance with the directive output from the layout composition section 206, and obtains the necessary font data. Then, using the obtained font data, the font expansion section 207 creates font data of the necessary size in accordance with the directive from the layout composition section 206, and outputs this font data to the print image expansion section 209. The font storage section 208 stores the font data.

The print image expansion section 209 creates print image data from the XML source and font data, and outputs this print image data to the output switching section 210. The print image expansion section 209 also outputs size information for the created print image data to the conversion ratio calculation section 214. This print image data size information indicates the number of vertical print pixels and the number of horizontal print pixels.

The output switching section 210 outputs print image data to the image conversion section 211 or printing section 213 based on the print preview or print directive from print data output from the request separation section 202.

When, for example, a directive from the request separation section 202 is for a print preview, the output switching section 210 outputs print image data to the image conversion section 211, and when a directive from the request separation section 202 is for printing, the output switching section 210 outputs print image data to the printing section 213.

The conversion ratio calculation section 214 calculates a conversion ratio that indicates the size ratio for converting print image data to preview data based on preview screen information of receiving apparatus 100 and print condition information, and outputs this conversion ratio to the image conversion section 211.

Specifically, when a print preview directive is received, the conversion ratio calculation section 214 calculates a conversion ratio indicating the size ratio for converting print image data to preview data from preview information and print image data size information, and outputs this conversion ratio to the image conversion section 211.

When a print preview directive is received, the image conversion section 211 converts print image data to preview data and outputs this preview data to the buffer 212. The conversion ratio calculated by the conversion ratio calculation section 214 is used as the ratio for converting print image data to preview data.

The buffer 212 holds preview data, and outputs this preview data to the interface section 201. When a print preview directive is received, the printing section 213 prints the print image data.

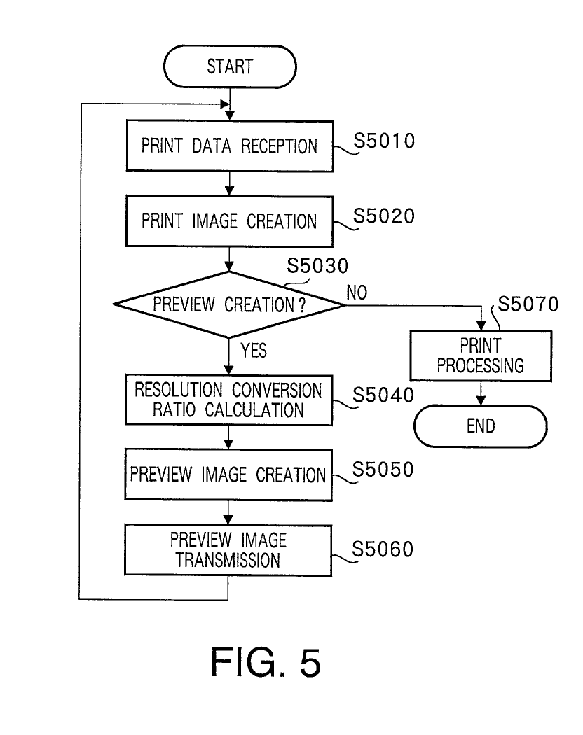

The operation of a printing apparatus of this embodiment will now be described using a flowchart. FIG. 5 is a flowchart showing an example of the operation of a printing apparatus of this embodiment.

In Step (hereinafter referred to as “S”) 5010, the interface section 201 receives print data. In S5020, the print image expansion section 209 creates print image data from print data.

In S5030, the output switching section 210 determines whether or not a directive output from the request separation section 202 is for a print preview. If the directive is for a print preview, the output switching section 210 outputs print image data to the image conversion section 211, and processing proceeds to S5040. If the directive is not for a print preview but for printing, the output switching section 210 outputs print image data to the printing section 213, and processing proceeds to S5070.

In S5040, the conversion ratio calculation section 214 calculates a conversion ratio indicating the size ratio for converting print image data to preview data from the number of preview data display pixels and print image data size information.

In S5050, the image conversion section 211 converts print image data to preview data. In S5060, the interface section 201 transmits the preview data to an external receiving apparatus, and processing returns to S5010.

In S5070, the printing section 213 prints print image data, and processing is terminated.

The processing that converts print image data to preview data will now be described.

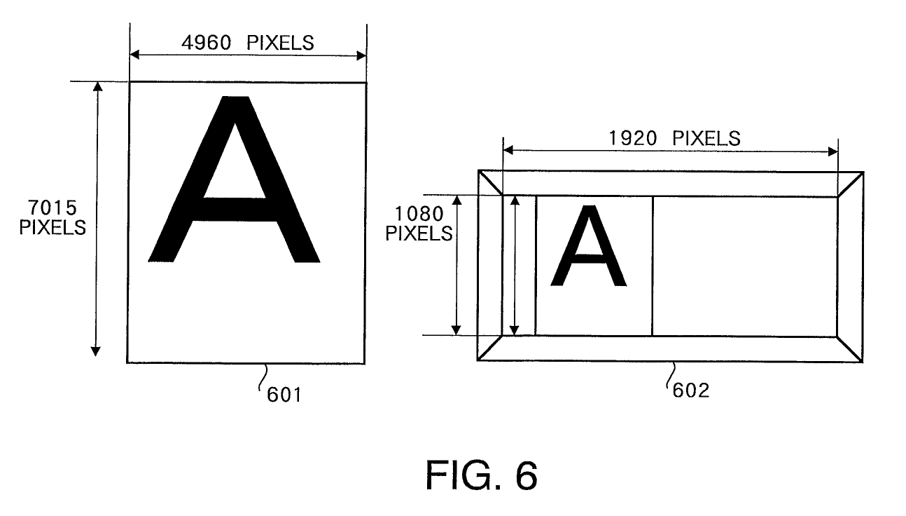

FIG. 6 is a drawing showing examples of print image data and preview data. Here, a case is described where the number of print image data pixels is greater than the number of pixels of the display area of the receiving apparatus. In FIG. 6, print image data is data that is printed in A4 size at a resolution of 600 DPI (Dots Per Inch). This print image data 601 is image data comprising 7015 pixels vertically and 4960 pixels horizontally.

When, for example, preview data is to be displayed with the entire display area of a receiver capable of display at a resolution of 1080 vertical pixels and 1920 horizontal pixels as a preview area 602, the number of pixels in a vertical side of the print image data 601 is greater than the number of pixels in a vertical side of the preview area 602.

Also, the number of pixels in a horizontal side of the print image data 601 is greater than the number of pixels in a horizontal side of the preview area 602. That is to say, if the whole of the print image data 601 is displayed directly in the display area of the receiving apparatus—that is, the preview area 602—it will only be possible to display part of the page. In order to display the entire print image data 601 page in the entire display area of the receiving apparatus—that is, the preview area 602—it is necessary to change the size of the print image data.

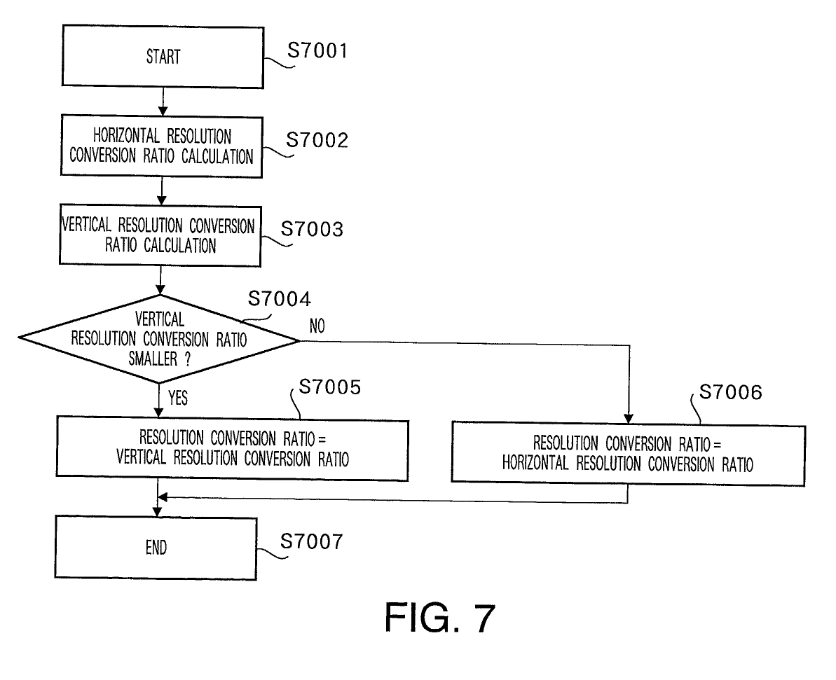

Resolution conversion calculation is described below. FIG. 7 is a flowchart showing resolution conversion ratio calculation.

In S7002, the horizontal resolution conversion ratio is calculated. The horizontal resolution ratio is a value obtained by dividing the number of horizontal pixels of the preview area by the number of horizontal pixels of the print image. The horizontal resolution of a print image for which a page can be accommodated horizontally in the preview area without protruding is determined from the product of this value and the horizontal resolution of the print image.

In S7003, the vertical resolution conversion ratio is calculated. The vertical resolution ratio is a value obtained by dividing the number of vertical pixels of the preview area by the number of vertical pixels of the print image. The vertical resolution of a print image for which a page can be accommodated vertically in the preview area without protruding is determined from the product of this value and the vertical resolution of the print image.

In S7004, the horizontal resolution conversion ratio and vertical resolution ratio are compared. By using the resolution conversion ratio with the smaller value as the overall resolution conversion ratio, it is possible to perform resolution conversion that avoids protrusion in either the horizontal or vertical direction. If the vertical resolution ratio is smaller in S7004, processing proceeds to S7005; otherwise, processing proceeds to S7006.

In S7005, the horizontal resolution ratio is made the overall resolution conversion ratio. In S7006, the vertical resolution conversion ratio is made the overall resolution conversion ratio.

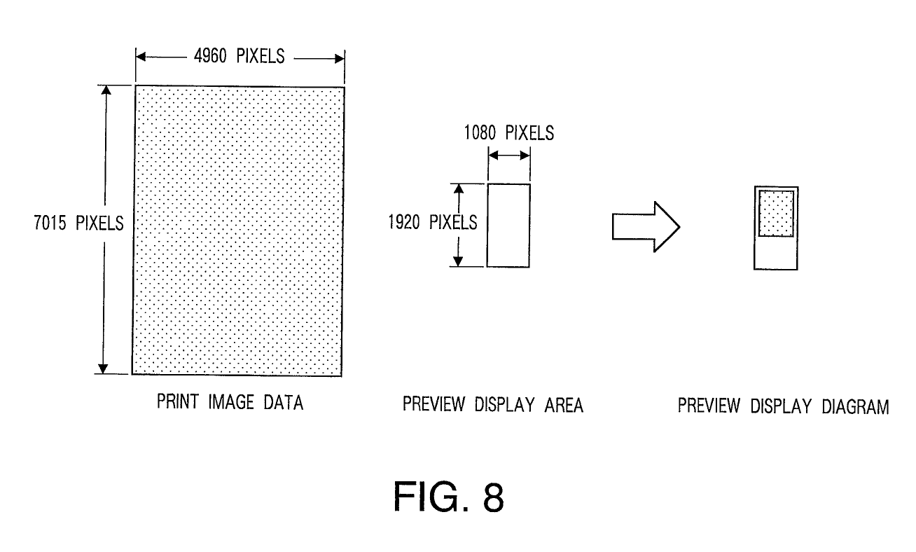

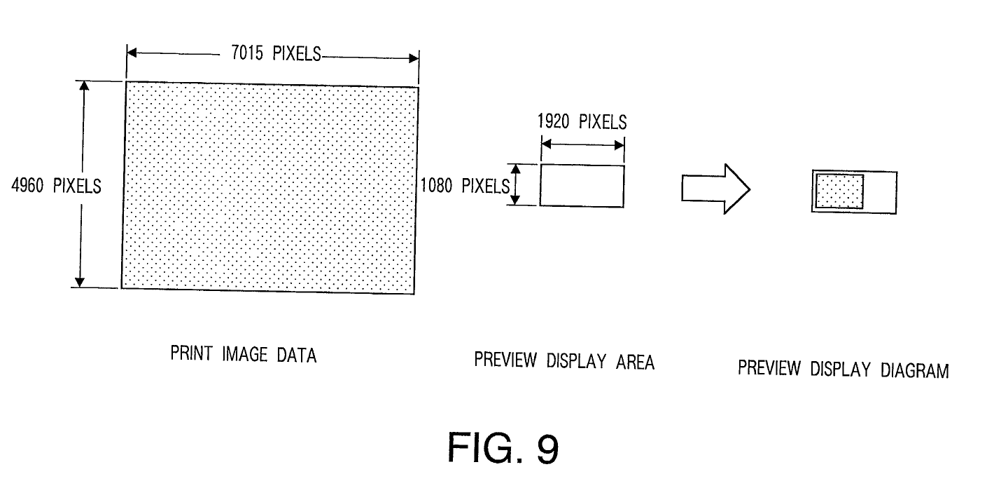

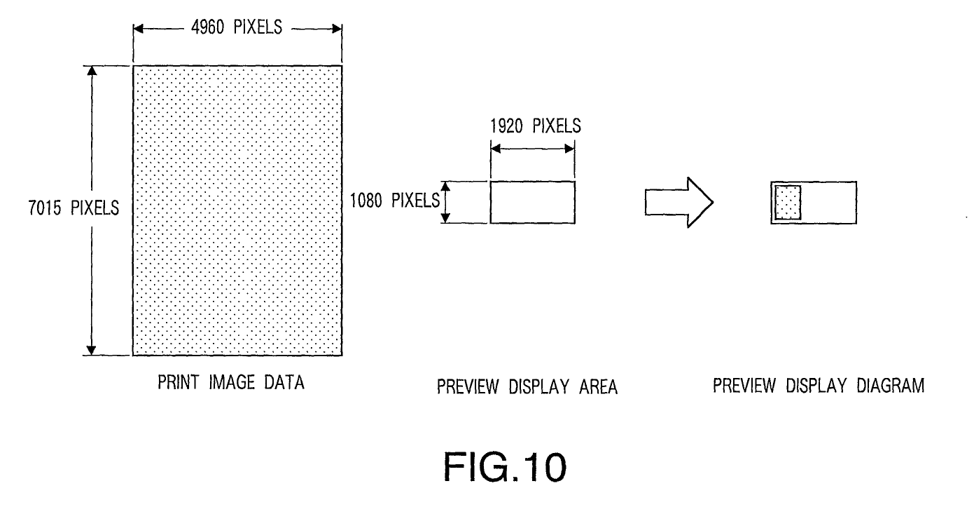

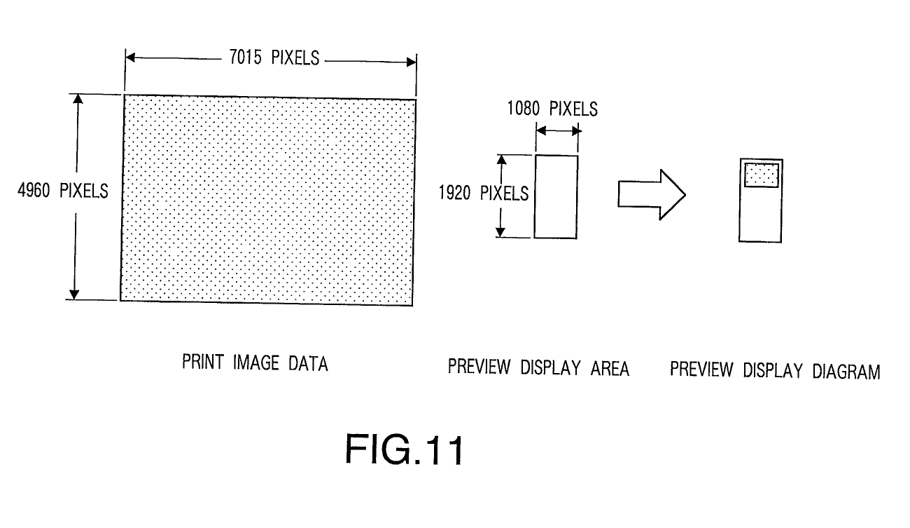

FIG. 8, FIG. 9, FIG. 10, and FIG. 11 are drawings showing sample previews according to different combinations of print image data and preview area.

FIG. 8 shows a case where both the print image data and the preview area are higher than they are wide. In this example it is assumed that the print image data has a horizontal resolution of 4960 pixels and a vertical resolution of 7015 pixels, and the preview area has a horizontal resolution of 1080 pixels and a vertical resolution of 1920 pixels. In this case, the horizontal resolution conversion ratio is 0.22 and the vertical resolution conversion ratio is 0.27. Thus, the overall resolution conversion ratio is 0.22.

When resolution conversion of print image data is performed on this basis, the display in the preview area is as shown in FIG. 8. The entire page is displayed, fitting exactly in the horizontal direction while leaving a margin in the vertical direction.

FIG. 9 shows a case where both the print image data and the preview area are wider than they are high. In this example it is assumed that the print image data has a horizontal resolution of 7015 pixels and a vertical resolution of 4960 pixels, and the preview area has a horizontal resolution of 1920 pixels and a vertical resolution of 1080 pixels. In this case, the vertical resolution conversion ratio is 0.22 and the horizontal resolution conversion ratio is 0.27. Thus, the overall resolution conversion ratio is 0.22.

When resolution conversion of print image data is performed on this basis, the display in the preview area is as shown in the right-hand drawing in FIG. 9. The entire page is displayed, fitting exactly in the vertical direction while leaving a slight margin in the horizontal direction.

FIG. 10 shows a case where the print image data is higher than it is wide, and the preview area is wider than it is high. In this example it is assumed that the print image data has a horizontal resolution of 4960 pixels and a vertical resolution of 7015 pixels, and the preview area has a horizontal resolution of 1920 pixels and a vertical resolution of 1080 pixels. In this case, the vertical resolution conversion ratio is 0.15 and the horizontal resolution conversion ratio is 0.39. Thus, the overall resolution conversion ratio is 0.15.

When resolution conversion of print image data is performed on this basis, the display in the preview area is as shown in the right-hand drawing in FIG. 10. The entire page is displayed, fitting exactly in the vertical direction while leaving a margin in the horizontal direction.

FIG. 11 shows a case where the print image data is wider than it is high, and the preview area is higher than it is wide. In this example it is assumed that the print image data has a horizontal resolution of 7015 pixels and a vertical resolution of 4960 pixels, and the preview area has a horizontal resolution of 1080 pixels and a vertical resolution of 1920 pixels. In this case, the vertical resolution conversion ratio is 0.39 and the horizontal resolution conversion ratio is 0.15. Thus, the overall resolution conversion ratio is 0.15.

When resolution conversion of print image data is performed on this basis, the display in the preview area is as shown in the right-hand drawing in FIG. 11. The entire page is displayed, fitting exactly in the horizontal direction while leaving a margin in the vertical direction.

Thus, a printing apparatus of this embodiment converts print image data to preview data with an image size obtained from an above-described conversion ratio so that all the image data for printing fits into the preview area of the receiving apparatus.

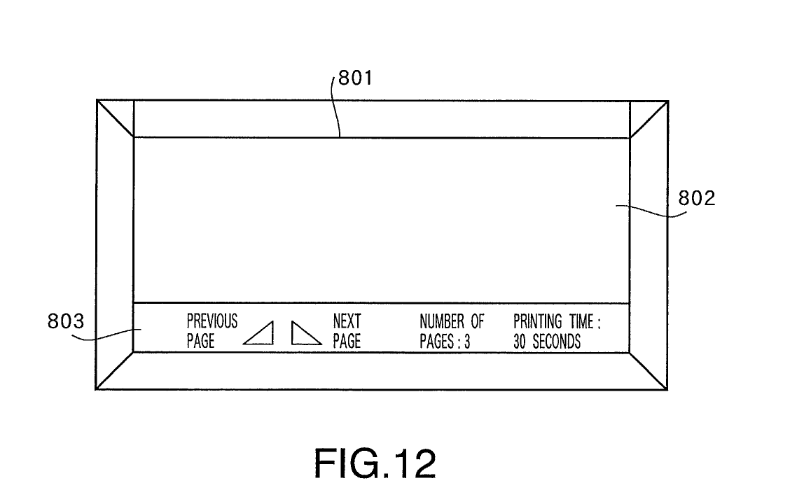

There are also cases where the preview area of the receiving apparatus uses only part of the display area. FIG. 12 is a drawing showing an example of receiving apparatus display. In FIG. 12, a receiving apparatus display section 801 displays an image transmitted by broadcasting or the like, a print data preview image, or information relating to operation of the receiving apparatus. The display section 801 is composed of a preview area 802 and a directive area 803 that displays printing-related directives and so forth.

The preview area 802 and directive area 803 are displayed consecutively in the vertical direction. In this case, the vertical number of pixels of the preview area 802 is the number obtained by subtracting the vertical number of pixels of the directive area 803 from the vertical number of pixels of the display section 801.

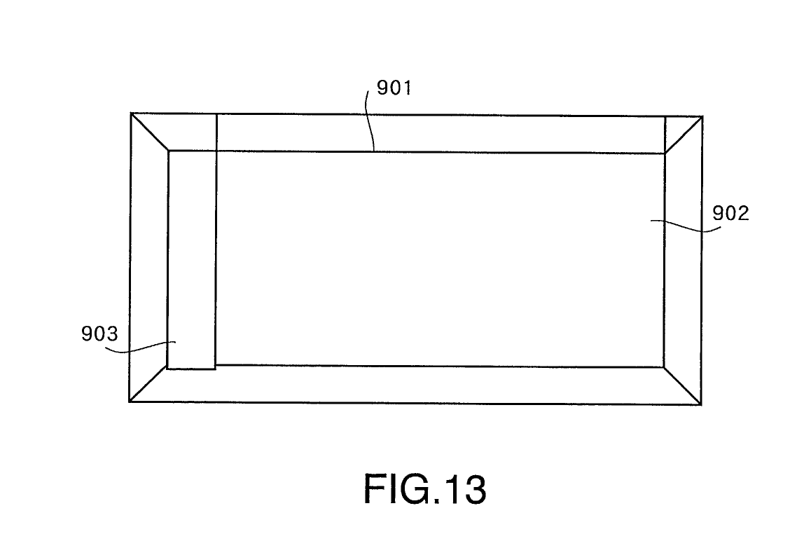

A preview area and a directive area that displays printing-related directives and the like may also perform display consecutively in the horizontal direction. FIG. 13 is a drawing showing an example of receiving apparatus display. In FIG. 13, a display section 901 is composed of a preview area 902 and a directive area 903 that displays printing-related directives and so forth.

The preview area 902 and directive area 903 are displayed consecutively in the horizontal direction. In this case, the horizontal number of pixels of the preview area 902 is the number obtained by subtracting the horizontal number of pixels of the directive area 903 from the horizontal number of pixels of the display section 901.

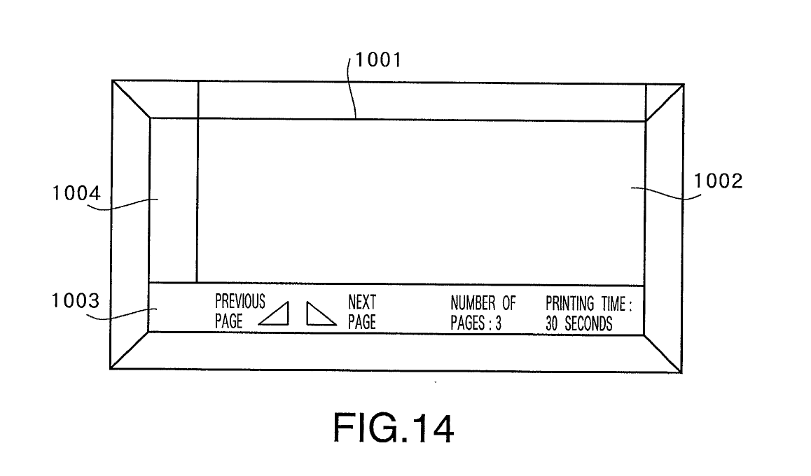

FIG. 14 is a drawing showing an example of receiving apparatus display. In FIG. 14, a display section 1001 is composed of a preview area 1002 and directive areas 1003 and 1004 that display printing-related directives and so forth.

The preview area 1002 and directive area 1003 are displayed consecutively in the vertical direction. In this case, the vertical number of pixels of the preview area 1002 is the number obtained by subtracting the vertical number of pixels of directive area 1003 from the vertical number of pixels of the display section 1001. The preview area 1002 and directive area 1004 are displayed consecutively in the horizontal direction. In this case, the horizontal number of pixels of the preview area 1002 is the number obtained by subtracting the horizontal number of pixels of directive area 1004 from the horizontal number of pixels of the display section 1001.

Thus, by making the size which is obtained by subtracting the number of pixels of directive area from the number of pixels of display section used as a preview area beforehand, it is possible to display preview image data, receiving apparatus information, and so forth, simultaneously.

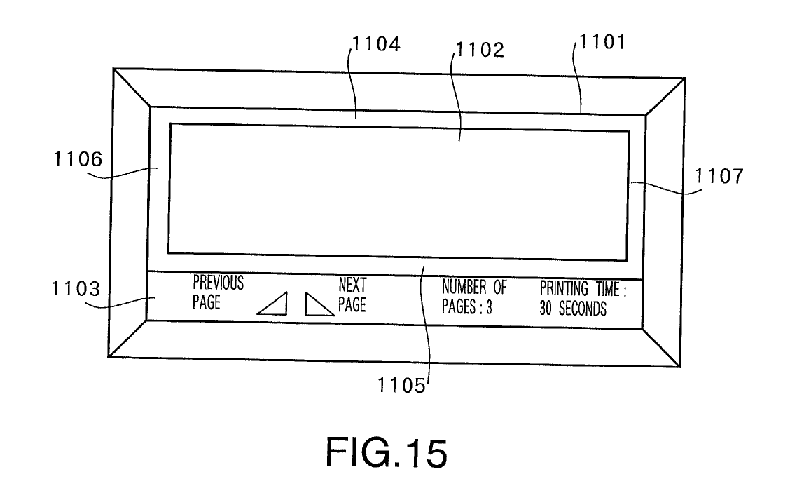

Furthermore, the number of pixels of preview data may be made smaller than the number of pixels of the receiving apparatus display area. FIG. 15 is a drawing showing an example of receiving apparatus display. In FIG. 15, a display section 1101 is composed of a preview area 1102 and a directive area 1103 that displays printing-related directives and so forth. Around the preview area 1102 is an area comprising a top margin 1104, bottom margin 1105, left margin 1106, and right margin 1107.

In the printing apparatus, the result of subtracting the horizontal number of pixels of the left margin 1106 and right margin 1107 from the horizontal number of pixels of the display section 1101 is taken as the horizontal number of pixels of a preview image, and the result of subtracting the vertical number of pixels of the top margin 1104, bottom margin 1105, and directive area 1103 from the vertical number of pixels of the display section 1101 is taken as the vertical number of pixels of a preview image, to give the size of the preview area 1102. The printing apparatus then creates preview data by converting print image data to a size that fits into the preview area 1102.

Thus, according to a printing apparatus of this embodiment, it is possible to confirm print contents with a display apparatus prior to printing from a printing apparatus by converting print image data based on the display capability of the display apparatus, and creating preview data.

(Embodiment 2)

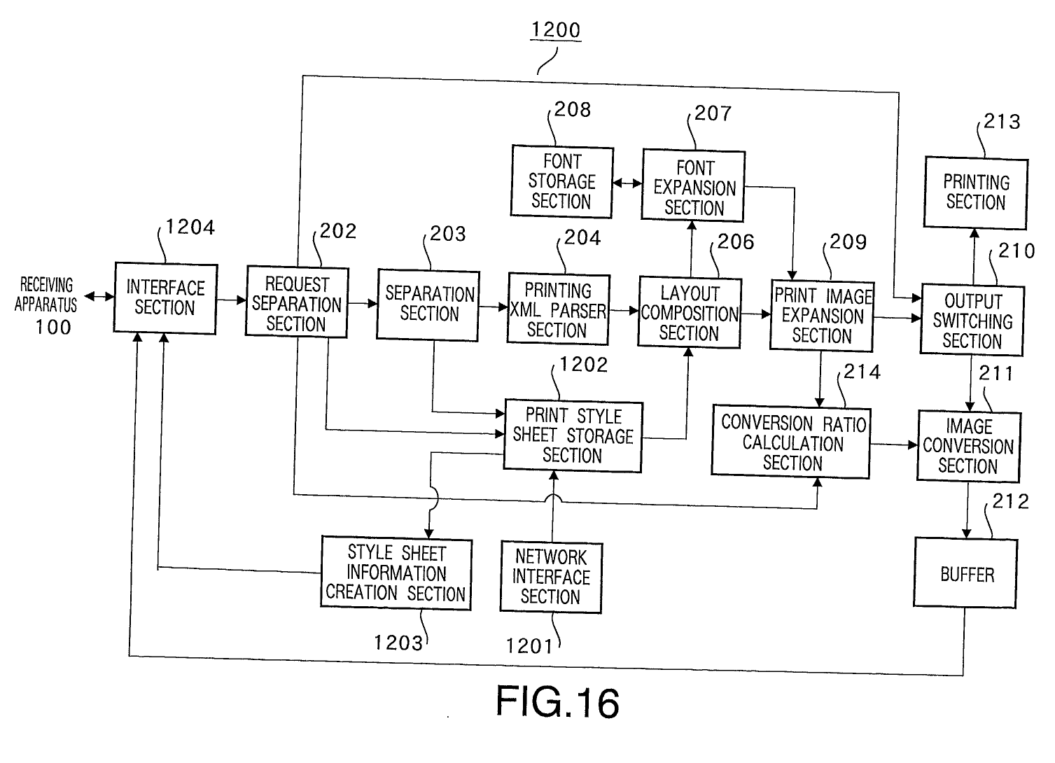

FIG. 16 is a block diagram showing the configuration of a printing apparatus according to Embodiment 2 of the present invention. Parts in FIG. 16 identical to those in FIG. 4 are assigned the same codes as in FIG. 4 and their detailed explanations are omitted.

The printing apparatus 1200 in FIG. 16 differs from the printing apparatus in FIG. 4 in being provided with a network interface section 1201, print style sheet storage section 1202, style sheet information creation section 1203, and interface section 1204, and in that a print style sheet is acquired from an external source, and print style sheet information stored by the printing apparatus is transmitted to a receiving apparatus.

The network interface section 1201 connects to an external network, such as the Internet, for example, obtains print style sheets from the network, and outputs those print style sheets to the print style sheet storage section 1202.

The print style sheet storage section 1202 stores print style sheets and outputs them to a layout composition section 206 in accordance with a directive output from a separation section 203. The print style sheet storage section 1202 also outputs information on types of stored print style sheets to the style sheet information creation section 1203.

The style sheet information creation section 1203 converts print style sheet type information to a format that can be displayed by the receiving apparatus 100, such as XML content format, for example, and outputs that information to the interface section 1204.

The interface section 1204 receives print data transmitted from the receiving apparatus 100, and outputs that print data to a request separation section 202. The interface section 1204 also outputs print style sheet format information output from the style sheet information creation section 1203 to the receiving apparatus 100.

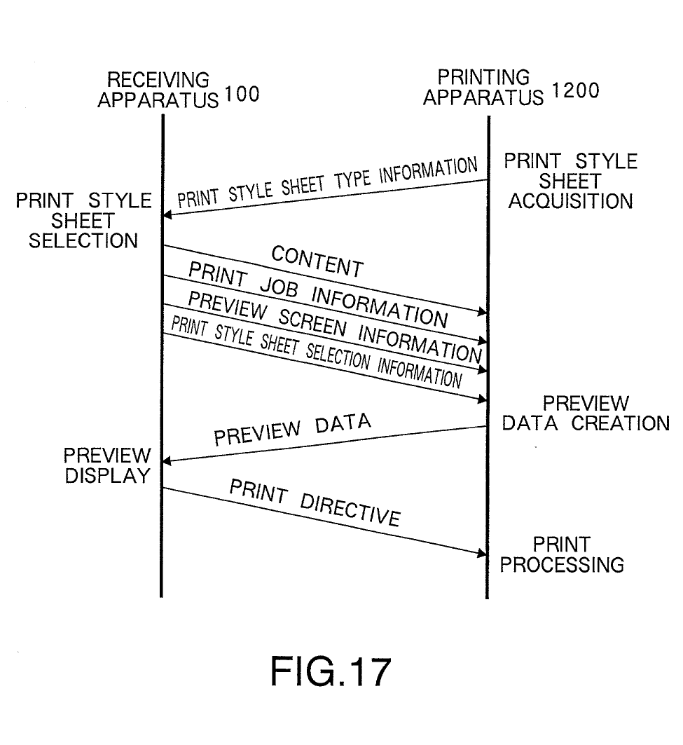

The communication procedure between the receiving apparatus 100 and printing apparatus 2800 will now be described. FIG. 17 is a sequence diagram showing an example of signal exchange between the receiving apparatus 100 and printing apparatus 1200. FIG. 17 illustrates the communication procedure when the printing apparatus 1200 outputs information on print style sheets acquired from an external source to the receiving apparatus 100.

In FIG. 17, the printing apparatus 1200 obtains print style sheets from an external source, and transmits information on types of stored print style sheets to the receiving apparatus 100.

The receiving apparatus 100 displays print style sheet type information, and prompts selection of the print style sheet to be used. The receiving apparatus 100 then outputs content to be printed, such as XML content, for example, from received broadcast content to the printing apparatus 1200. Here, XML content includes an XML instance and style sheet.

Then the receiving apparatus 100 outputs print job information indicating conditions necessary for printing, such as the printing paper size, resolution, and printing direction, for example, and selection information for the print style sheet to be used, to the printing apparatus 1200. The receiving apparatus 100 then outputs preview information comprising conditions for displaying preview data, which is an image when print output is displayed on a screen, to the printing apparatus 1200.

The printing apparatus 1200 creates preview data from the XML content, print job information, and preview information, and outputs this preview data to the receiving apparatus 100.

The receiving apparatus 100 displays the preview data, and prompts input as to whether or not printing is to be performed. When a directive to perform printing is input, the receiving apparatus 100 outputs a print directive to the printing apparatus 1200, and the printing apparatus 1200 prints XML content in accordance with the directive. When XML content and print job information are not stored in the printing apparatus 1200, the receiving apparatus 100 may again output XML content and print job information to the printing apparatus 1200 together with a print directive.

Thus, according to a printing apparatus of this embodiment, it is possible to increase the types of print style sheets used for printing as appropriate by acquiring print style sheets from an external source and transmitting information on print style sheets stored by the printing apparatus to a receiving apparatus. Further, by displaying the information on print style sheets stored by the printing apparatus on the receiving apparatus, it is possible for users to select and confirm the print style sheets.

It is also possible for a removable storage medium to be provided instead of the network interface section 1201, and for print style sheets to be output to the print style sheet storage section 1202 via this storage medium.

(Embodiment 3)

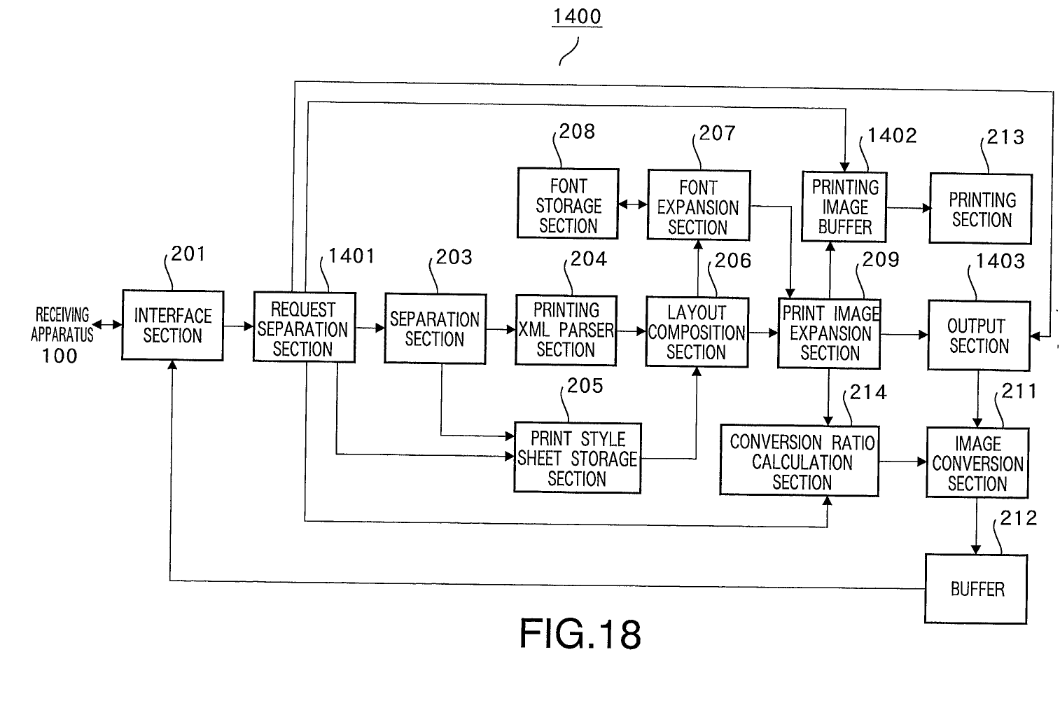

FIG. 18 is a block diagram showing the configuration of a printing apparatus according to Embodiment 3 of the present invention. Parts in FIG. 18 identical to those in FIG. 4 are assigned the same codes as in FIG. 4 and their detailed explanations are omitted.

The printing apparatus 1400 in FIG. 18 differs from the printing apparatus in FIG. 4 in being provided with a request separation section 1401 and print image buffer 1402, and in that created print image data is temporarily stored, and when there is a print directive after preview output, printing is performed using the temporarily stored print image data.

The request separation section 1401 extracts a print preview or print directive from the print data and outputs this to an output switching section 210. The request separation section 1401 also extracts a print preview directive and preview information from the print data and outputs these to a conversion ratio calculation section 214. In addition, the request separation section 1401 outputs the print data to a separation section 203.

The request separation section 1401 also extracts a print directive from the print data, and outputs this print directive to the print image buffer 1402.

A print image expansion section 209 creates print image data from XML source and font data, and outputs this print image data to the print image buffer 1402 and an output section 1403. The print image expansion section 209 also outputs size information for the created print image data to the conversion ratio calculation section 214.

The print image buffer 1402 stores print image data, and outputs the print image data to a printing section 213 when a print directive is output from the request separation section 1401.

When a print preview directive is output from the request separation section 1401, the output section 1403 outputs the print image data to an image conversion section 211.

Thus, according to a printing apparatus of this embodiment, by temporarily storing created print image data and performing printing using the temporarily stored print image data when there is a print directive after preview output, it is possible to create print image data only when preview data is created, thus enabling processing time when printing to be shortened.

(Embodiment 4)

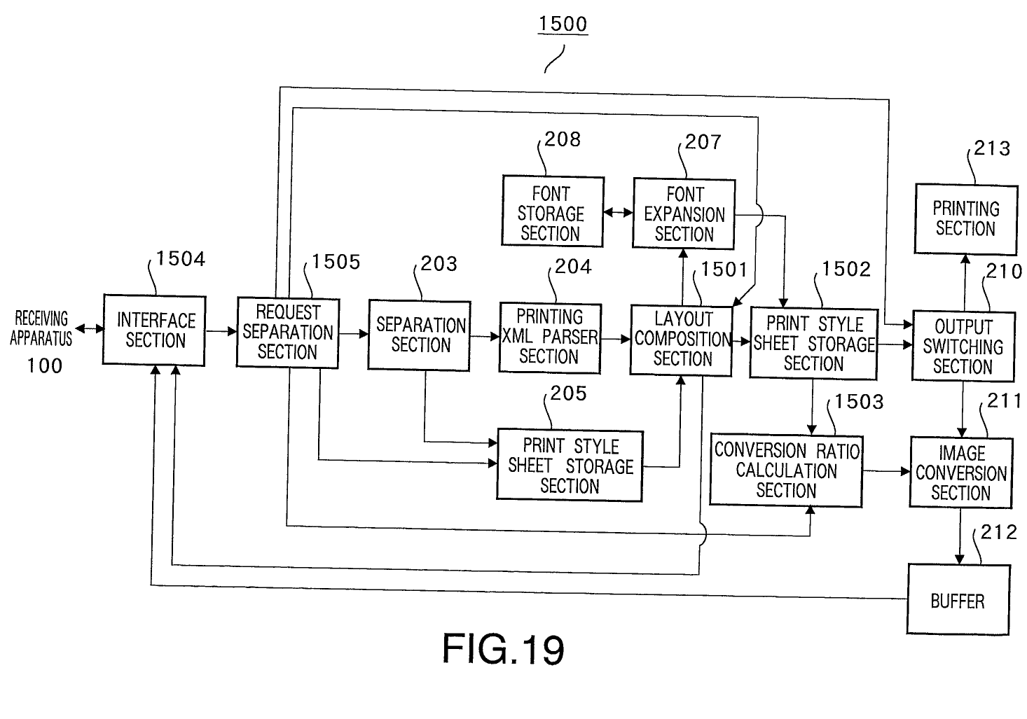

FIG. 19 is a block diagram showing the configuration of a printing apparatus according to Embodiment 4 of the present invention. Parts in FIG. 19 identical to those in FIG. 4 are assigned the same codes as in FIG. 4 and their detailed explanations are omitted.

The printing apparatus 1500 in FIG. 19 differs from the printing apparatus in FIG. 4 in being provided with a layout composition section 1501, print image expansion section 1502, conversion ratio calculation section 1503, and interface section 1504, and in that preview images are created on a page-by-page basis.

A printing XML parser section 204 performs parsing processing on a received XML instance with an XML parser, parses a DTD document and XML document and creates a document object, which it outputs to the layout composition section 1501.

Using the document object and print style sheet expanded by a printing XML parser section 204, the layout composition section 1501 outputs XML source to the print image expansion section 1502 on a page-by-page basis. Also, when a directive to output the next page of preview data is output from a request separation section 1505 described later herein, the layout composition section 1501 outputs the indicated page of XML source to the print image expansion section 1502.

The layout composition section 1501 also gives a directive for a font necessary for creation of print image data to a font expansion section 207.

The font expansion section 207 refers a font storage section 208 in accordance with the directive output from the layout composition section 1501, and obtains the necessary font. Then, using the obtained font data, the font expansion section 207 creates font data of the necessary size in accordance with the directive from the layout composition section 1501, and outputs this font data to the print image expansion section 1502. The font storage section 208 stores the font data.

The print image expansion section 1502 creates one page of print image data from XML source and font data output for one page, and outputs this print image data to an output switching section 210. The print image expansion section 1502 also outputs size information for the created print image data to the conversion ratio calculation section 1503.

When a print preview directive is received, the conversion ratio calculation section 1503 calculates a conversion ratio that indicates the size ratio for converting print image data to preview data based on preview information and print image data size information, and outputs this conversion ratio to an image conversion section 211.

The interface section 1504 receives print data transmitted from the receiving apparatus 100, and outputs that print data to the request separation section 1505. The interface section 1504 also transmits preview data output from a buffer 212 described later herein to the receiving apparatus 100.

The request separation section 1505 extracts a print preview or print directive from the print data and outputs this to an output switching section 210. The request separation section 1505 also extracts a print preview directive and preview information from the print data and outputs these to the conversion ratio calculation section 1503. In addition, the request separation section 1505 outputs the print data to a separation section 203. Furthermore, the request separation section 1505 outputs to the layout composition section 1501 a directive to output the next page of preview data.

Thus, according to a printing apparatus of this embodiment, by creating preview images on a page-by-page basis in accordance with directives from a receiving apparatus, when printing a plurality of pages, it is possible to make the time before a preview of the first page is displayed shorter than by creating overall preview images. Also, since preview images are created on a page-by-page basis, the buffer 212 need only store one page of preview image data, thus enabling system resources to be reduced.

In this embodiment one page of preview data is created each time a preview directive is input, but it is also possible for one page of preview data to be transmitted sequentially from all the pages of created preview data each time a preview directive is input. In this case, the procedure can be implemented by creating all pages of print data and storing this preview data in the buffer 212, and outputting a directive from the request separation section 1505 to the buffer for transmission of one page of the created preview data each time a preview directive is input.

(Embodiment 5)

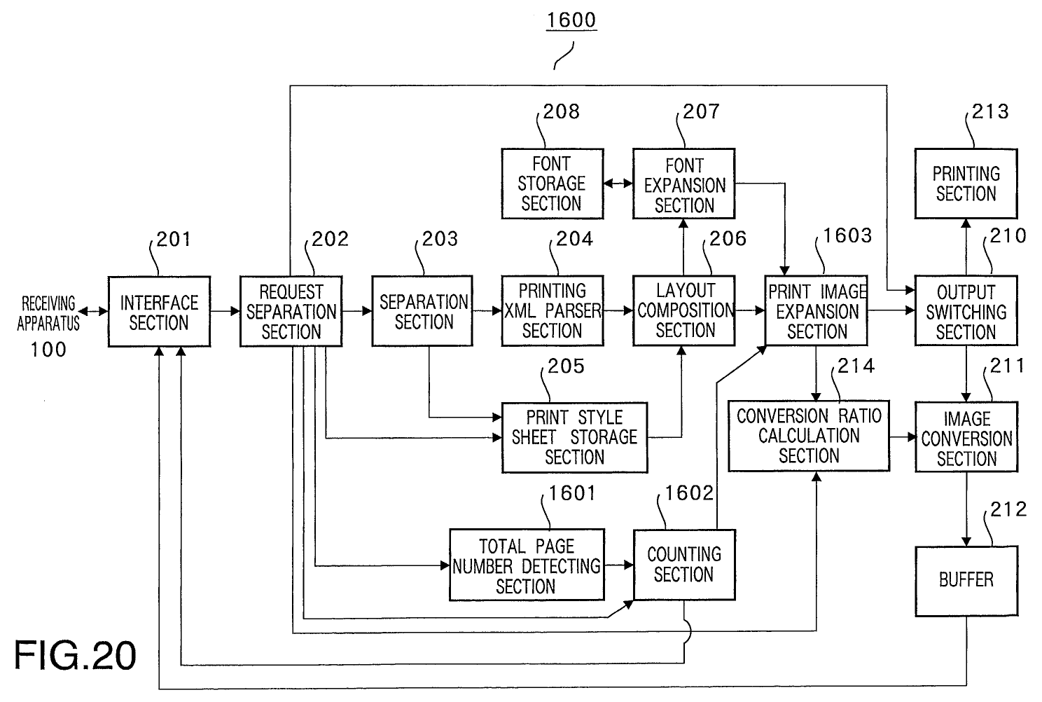

FIG. 20 is a block diagram showing the configuration of a printing apparatus according to Embodiment 5 of the present invention. Parts in FIG. 20 identical to those in FIG. 4 are assigned the same codes as in FIG. 4 and their detailed explanations are omitted.

The printing apparatus 1600 in FIG. 20 differs from the printing apparatus in FIG. 4 in being provided with a total page number detecting section 1601, counting section 1602, and print image expansion section 1603, and in that the number of pages for which preview data is created is counted, and it is determined whether or not preview data for all the pages to be printed has been created.

A request separation section 202 extracts a print preview or print directive from print data and outputs this to an output switching section 210. The request separation section 202 also extracts a print preview directive and preview information from the print data and outputs these to a conversion ratio calculation section 214 and the total page number detecting section 1601. In addition, the request separation section 202 outputs print data to a separation section 203, and also extracts a print preview directive from the print data and outputs this directive to the counting section 1602.

The total page number detecting section 1601 calculates the number of pages to be printed from the print data, and outputs this number to the counting section 1602.

The counting section 1602 outputs to an interface section 201 the result of subtracting the number of pages for which a print preview directive was given from the number of pages to be printed. In addition, the counting section 1602 outputs a print preview directive to the print image expansion section 1603.

The print image expansion section 1603 creates print image data from XML source and font data in accordance with the directive from the counting section 1602, and outputs this print image data to the output switching section 210. The print image expansion section 1603 also outputs size information for the created print image data to the conversion ratio calculation section 214.

Thus, according to a printing apparatus of this embodiment, by counting the number of pages for which preview data is created and determining whether or not preview data for all the pages to be printed has been created, it is possible to confirm whether or not preview data has been created up to the end of the content to be printed when preview data is created on a page-by-page basis.

Moreover, it is possible to output the number of pages to be printed to a receiving apparatus, and display this number of pages in the receiving apparatus. In this case, the procedure can be implemented by having the total page number detecting section 1601 output the number of pages to be printed to the receiving apparatus 100 via the interface section 201.

Further, it is possible to output the total number of pages to a receiving apparatus, and display this number of pages in the receiving apparatus. In this case, total page number detecting section 1601 outputs the total number of pages to the receiving apparatus 100 via the interface section 201.

(Embodiment 6)

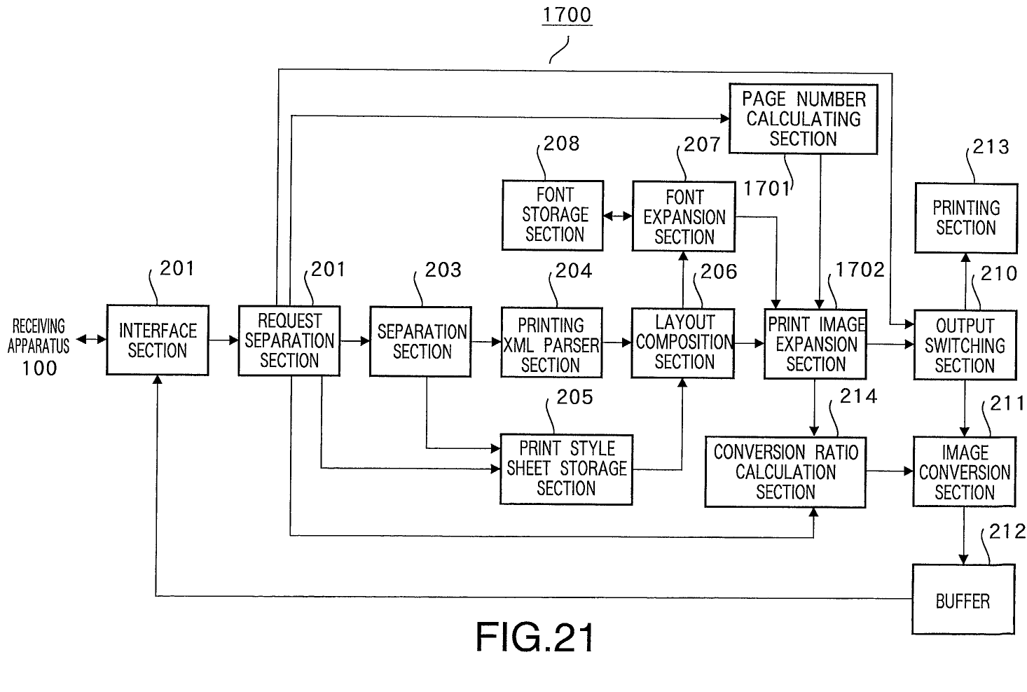

FIG. 21 is a block diagram showing the configuration of a printing apparatus according to Embodiment 6 of the present invention. Parts in FIG. 21 identical to those in FIG. 4 are assigned the same codes as in FIG. 4 and their detailed explanations are omitted.

The printing apparatus 1700 in FIG. 21 differs from the printing apparatus in FIG. 4 in being provided with a page number calculating section 1701 and print image expansion section 1702,and in that preview data is created every number of pages displayable on the preview screen at one time, based on preview screen information and print condition information. The page number calculating section 1701 calculates the number of pages displayable on the preview screen at one time, based on preview screen information and print condition information output from a request separation section 202, and outputs this number of pages to the print image expansion section 1702.

The print image expansion section 1702 creates print image data from XML source and font data for every number of pages displayable on the preview screen at one time, and outputs this print image data to an output switching section 210. The print image expansion section 1702 also outputs size information for the created print image data to a conversion ratio calculation section 214.

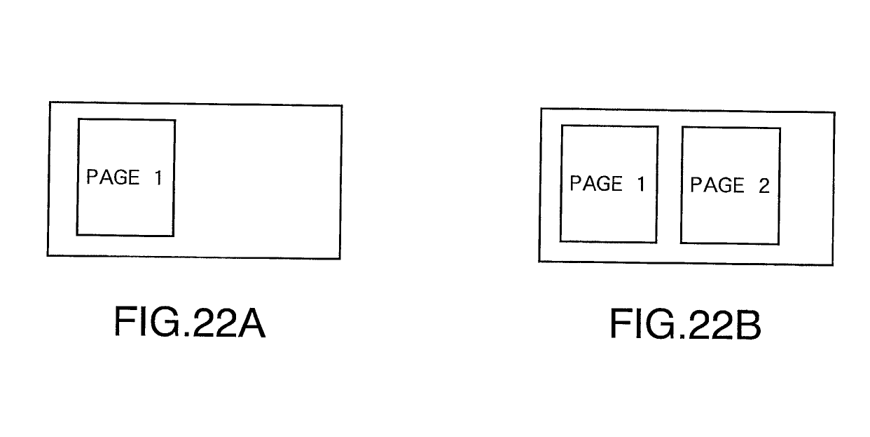

The way in which the number of pages that can be displayed is calculated will now be described, using drawings. FIG. 22(A) and FIG. 22(B) comprises conceptual diagrams illustrating preview display. FIG. 22(A) shows a case where, as the result of resolution conversion, a preview image fits exactly in the vertical direction but a margin is left in the horizontal direction.

In this case, the number of pages that can be displayed at the same time in the preview area is calculated by dividing the horizontal number of pixels of the preview area by the horizontal number of pixels of the preview image. Space between pages may also be taken into consideration in this calculation of the number of pages. A sample display result is shown in FIG. 22(B). In FIG. 22(B), two preview image pages can be displayed.

Although not illustrated with drawings, the number of pages that can be displayed in a preview area can be calculated using a similar method when there is a margin in the vertical direction.

Thus, according to a printing apparatus of this embodiment, it is possible to display a plurality of preview pages on a preview screen by calculating the number of pages that can be displayed on the preview screen at one time, based on preview screen information and print condition information and creating preview image data for pages that can be displayed on the preview screen at one time.

(Embodiment 7)

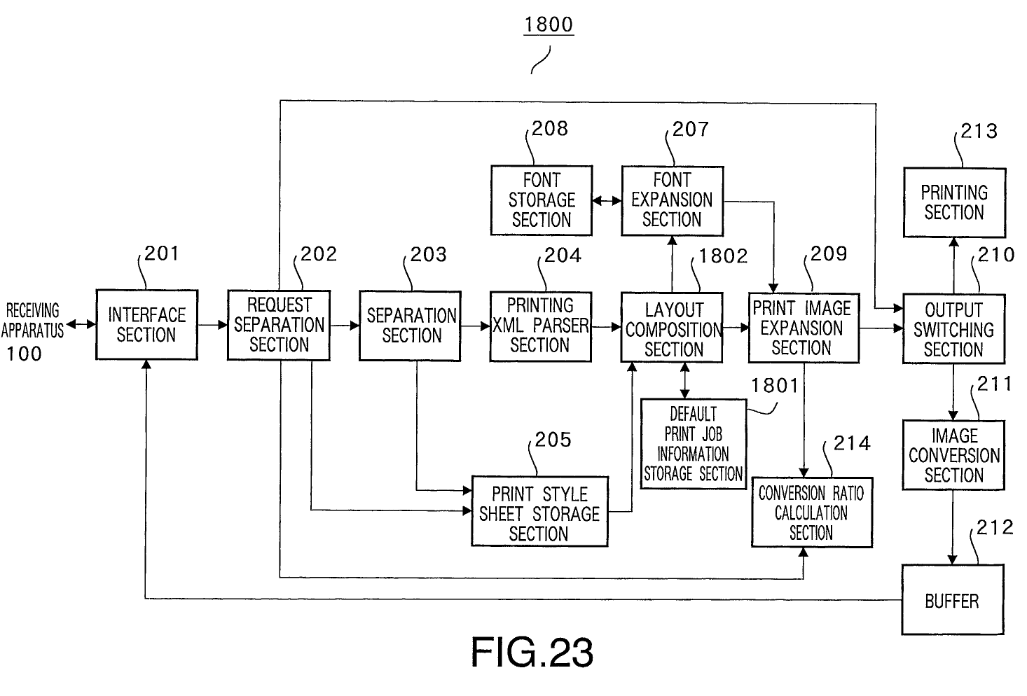

FIG. 23 is a block diagram showing the configuration of a printing apparatus according to Embodiment 7 of the present invention. Parts in FIG. 23 identical to those in FIG. 4 are assigned the same codes as in FIG. 4 and their detailed explanations are omitted.

The printing apparatus 1800 in FIG. 23 differs from the printing apparatus in FIG. 4 in being provided with a default print job information storage section 1801 and layout composition section 1802, and in that default print job information is prepared beforehand, this being print job information used when print job information has not been explicitly specified by a receiving apparatus 100.

The default print job information storage section 1801 stores default print job information-that is, print job information used when print job information to be used for printing has not been explicitly specified.

Thus, according to a printing apparatus of this embodiment, by preparing beforehand default print job information that is used when print job information to be used for printing has not been explicitly specified, it is possible to create preview data without print job information being specified by a receiving apparatus, enabling operation to be simplified.

(Embodiment 8)

In Embodiment 8, an example is described in which differences between print results and a display apparatus are taken into consideration, and preview data for a print preview is created by performing rasterization processing on print data based on the display capability of the receiving apparatus (client apparatus).

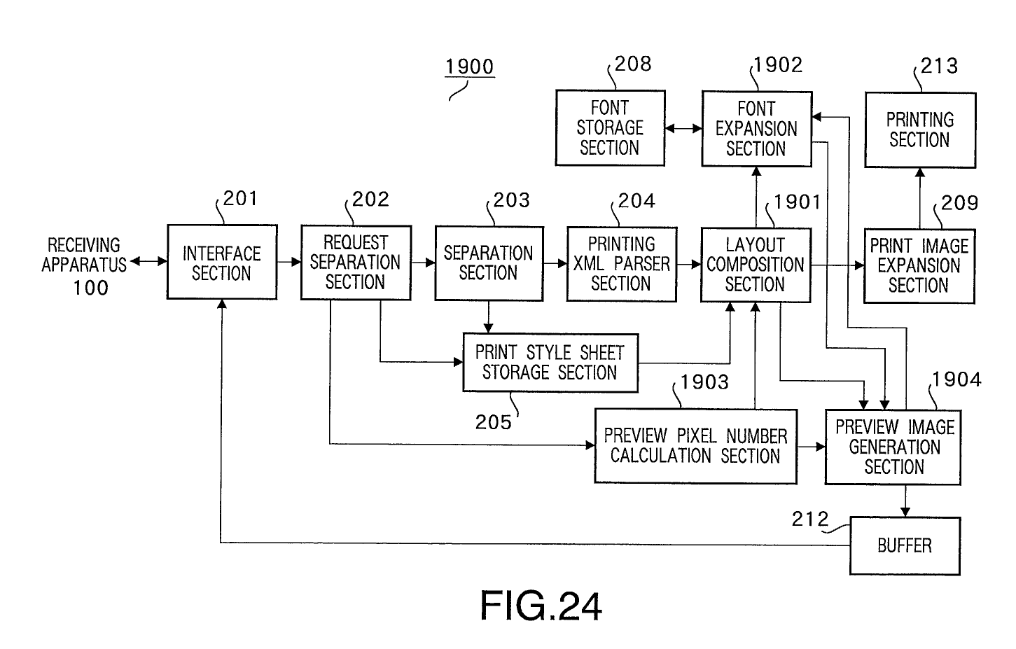

FIG. 24 is a block diagram showing the configuration of a printing apparatus according to Embodiment 8 of the present invention. Parts in FIG. 24 identical to those in FIG. 4 are assigned the same codes as in FIG. 4 and their detailed explanations are omitted.

The printing apparatus 1900 in FIG. 24 differs from the printing apparatus in FIG. 4 in being provided with a layout calculation section 1901, font expansion section 1902, preview pixel number calculation section 1903, and preview image generation section 1904,and in that the display layout of a preview image is calculated based on the number of pixels of preview data to be displayed, and preview data is created by performing rasterization processing on print data based on the number of pixels of that preview data and that display layout.

The layout calculation section 1901 creates preview layout information based on a document object and print style sheet expanded by a printing XML parser section 204, font expansion information output from the font expansion section 1902, and the number of preview pixels obtained by the preview pixel number calculation section 1903, and outputs this preview layout information to the preview image generation section 1904.

Preview layout information is layout specific information for the preview display space of a document object expanded by the printing XML parser section 204, comprising coordinate information (X-coordinate value and Y-coordinate value) and size information (width and length). There is coordinate information and size information for each document object, with a normal document often being composed of a plurality of document objects, and preview layout information also often being composed of coordinate information for a plurality of objects.

A preview display space is a dimensionless coordinate system corresponding on a one-to-one basis to a preview area shown in FIG. 8, FIG. 9, FIG. 10, or FIG. 11. The difference between a preview display area and a preview display space is that a preview display area is a physical coordinate system that has units called pixels, whereas a preview display space is a dimensionless coordinate system that has no units. A preview display space is a coordinate system with the top-left corner as the origin, a horizontal X-axis, and a vertical Y-axis. Position and occupied area in the preview display area of a document object can be specified uniquely by X-coordinate value, Y-coordinate value, width, and length, in the document object preview display space.

In position and size determination for a document object, it is possible to indicate a relative positional relationship in a preview display space, and in a preview display space the domain and variable type of an X-coordinate value and Y-coordinate value are arbitrary.

For example, the domain of the X-coordinate value and Y-coordinate value may be made a real number from 0 to 1, or may be made an integer from 0 to 100,000. Coordinate value 0.5 when the domain is a range from 0 to 1 is equivalent to coordinate value 50,000 when the domain is a range from 0 to 100,000.

The font expansion section 1902 refers a font storage section 208 in accordance with a directive from the layout calculation section 1901 or preview image generation section 1904, and obtains font data necessary for a preview. Then the font expansion section 1902 creates font data of the size to be used for print image creation from this font data in accordance with a directive from the layout calculation section 1901, and outputs this font data to the preview image generation section 1904. The font storage section 208 stores the font data.

The preview pixel number calculation section 1903 calculates the size for displaying print image data based on print condition information. In addition, the preview pixel number calculation section 1903 calculates the resolution conversion ratio for converting from the print image data size to the preview image data size, based on preview screen information output from the receiving apparatus 100, multiplies this resolution conversion ratio by the print image data size, and outputs the result of the multiplication to the layout calculation section 1901 and preview image generation section 1904 as the number of preview data pixels.

For example, a method may be used whereby a resolution conversion ratio is calculated that indicates the size ratio for converting print image data to preview data based on preview information and print image data size information as described in Embodiment 1.

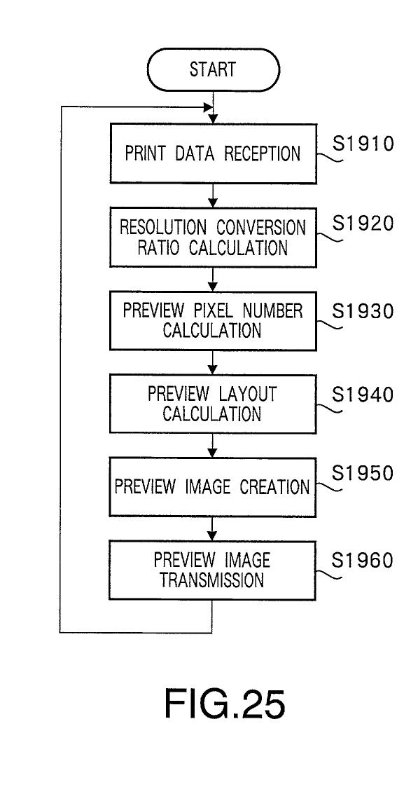

The operation of a printing apparatus of this embodiment will now be described using a flowchart. FIG. 25 is a flowchart showing an example of the operation of a printing apparatus of this embodiment.

In S1910, an interface section 201 receives print data. In S1920, the preview pixel number calculation section 1903 calculates a resolution conversion ratio that indicates the size ratio for converting print image data to preview data based on the number of display pixels of the preview area and print image data size information.

In S1930, the preview pixel number calculation section 1903 calculates the number of preview data pixels based on the resolution conversion ratio calculated in S1920 and print image data size information.

In S1940, the layout calculation section 1901 calculates preview data layout information based on the number of preview data pixels calculated in S1930 and font expansion information output from the font expansion section 1902.

In S1950, the preview image generation section 1904 generates a preview image based on preview data layout information calculated in S1940, the number of preview data pixels calculated in S1930, and font expansion information output from the font expansion section 1902. This image processing is rasterization processing that creates raster data constituting a collection of small points from text or image data.

In S1960, the interface section 201 transmits preview data to an external receiving apparatus, and processing returns to S1910.

Thus, according to a printing apparatus of this embodiment, it is possible to confirm print contents with a display apparatus prior to printing from a printing apparatus by calculating the display layout of a preview image based on the number of pixels of preview data to be displayed, and creating preview data by performing rasterization processing on print data based on the number of pixels of that preview data and that display layout.

That is to say, according to a printing apparatus of this embodiment, it is possible to create preview data without the need for work memory for expanding print image data in a printing apparatus and without imposing a load of expanding print image data on the printing apparatus, by directly creating preview data based on the number of preview data pixels without creating print image data whose data size increases, when generating preview data.

(Embodiment 9)

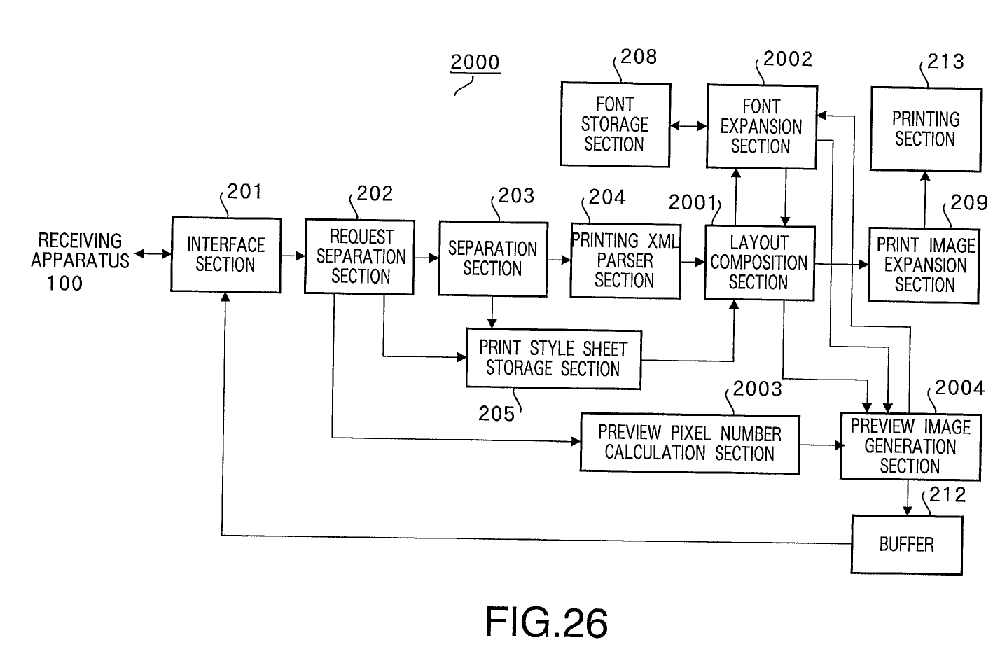

FIG. 26 is a block diagram showing the configuration of a printing apparatus according to Embodiment 9 of the present invention. Parts in FIG. 26 identical to those in FIG. 4 are assigned the same codes as in FIG. 4 and their detailed explanations are omitted.

The printing apparatus 2000 in FIG. 26 differs from the printing apparatus in FIG. 4 in being provided with a layout calculation section 2001, font expansion section 2002, preview pixel number calculation section 2003, and preview image generation section 2004,and in that the layout of a print image is calculated based on the number of pixels of the print image, and preview data is created by performing rasterization processing on print data based on the number of pixels of that preview data and that print image layout.

The layout calculation section 2001 creates preview layout information based on a document object and print style sheet expanded by the printing XML parser section 204, font expansion information output from the font expansion section 2002, and the number of print pixels, and outputs this preview layout information to the preview image generation section 2004.

The font expansion section 2002 refers a font storage section 208 in accordance with a directive from the layout calculation section 2001 or preview image generation section 2004, and obtains font data necessary for a preview. Then the font expansion section 2002 creates font data of the size to be used for print image creation from this font data in accordance with a directive from the layout calculation section 2001, and outputs this font data to the preview image generation section 2004. The font storage section 208 stores the font data.

The preview pixel number calculation section 2003 calculates the size for displaying print image data based on print condition information. In addition, the preview pixel number calculation section 2003 calculates the resolution conversion ratio for converting from the print image data size to the preview image data size, based on preview screen information output from the receiving apparatus 100, multiplies this resolution conversion ratio by the print image data size, and outputs the result of the multiplication to the preview image generation section 2004 as the number of preview data pixels.

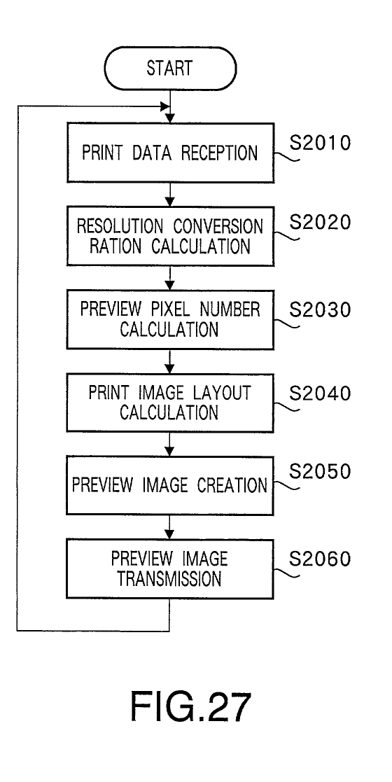

The operation of a printing apparatus of this embodiment will now be described using a flowchart. FIG. 27 is a flowchart showing an example of the operation of a printing apparatus of this embodiment.

In S2010, an interface section 201 receives print data. In S2020, the preview pixel number calculation section 2003 calculates a resolution conversion ratio that indicates the size ratio for converting print image data to preview data based on the number of display pixels of the preview area and print image data size information.

In S2030, the preview pixel number calculation section 2003 calculates the number of preview data pixels based on the resolution conversion ratio calculated in S2020 and print image data size information.

In S2040, the layout calculation section 2001 creates print image layout information based on font expansion information generated by the font expansion section 2002 based on the number of print pixels.

In S2050, the preview image generation section 2004 creates a preview image using print image layout information created in S2040, the number of preview data pixels calculated in S2030, and font expansion information from the font expansion section 2002. This image processing is rasterization processing that creates raster data constituting a collection of small points from text or image data.

In S2060, the interface section 201 transmits preview data to an external receiving apparatus, and processing returns to S2010.

Thus, according to a printing apparatus of this embodiment, it is possible to confirm print contents with a display apparatus prior to printing from a printing apparatus by calculating the print image layout based on the number of print image pixels, and creating preview data by performing rasterization processing on print data based on that number of preview data pixels and that print image layout.

That is to say, according to a printing apparatus of this embodiment, it is possible to create preview data without the need for work memory for expanding print image data in a printing apparatus and without imposing a load of expanding print image data on the printing apparatus, by directly creating preview data based on the number of preview data pixels without creating print image data whose data size increases, when generating preview data.

Also, according to a printing apparatus of this embodiment, it is possible to display a preview image closely resembling a print image by creating preview data layout information from print image layout information.

In Embodiments 1 through 9, a case is described where XML content is composed of text only, but image data may also be included in XML content. In this case, since normal image data is compressed, means for decompressing and restoring this data must be provided separately on the printing apparatus side. Furthermore, it goes without saying that the layout processing section performs image data layout calculation processing.

Also, in Embodiments 1 through 9, a print style sheet is included in XML content sent from the receiving apparatus to the printing apparatus, but a print style sheet need not be included. A print style sheet stored in a print style sheet storage section of the printing apparatus at the time of shipment, for example, may be used as a print style sheet in this case.

Further, in Embodiments 1 to 9 a document object output to the layout combining section is a structured document forming a tree structure, but other structures may be used in addition to the tree structure.

Moreover, in the above embodiments the descriptions have referred to the use of a resolution conversion ratio, but the resolution conversion ratio may also be made a pixel number conversion ratio. Here, a resolution conversion ratio is a conversion ratio obtained from the ratio of print image resolution to preview image resolution, and a pixel number conversion ratio is a conversion ratio obtained from the ratio of the number of print image pixels to the number of preview image pixels.

[Printing Time Estimation]

The gist of the present invention is to estimate the time necessary for printing on an object-by-object basis for content to be printed, and find the sum total of the printing times for all objects to be printed.

(Embodiment 10)

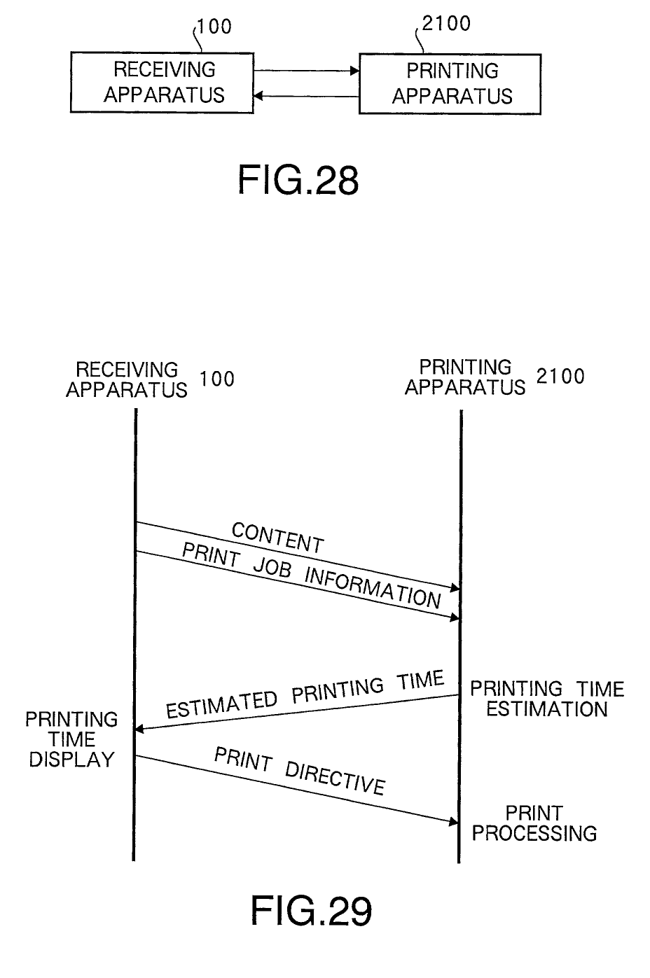

FIG. 28 is a drawing showing the configuration of a receiving apparatus and printing apparatus according to Embodiment 10 of the present invention.

In FIG. 28, a receiving apparatus 100 receives a digital broadcast or similar signal and displays broadcast contents. When the printing time for broadcast contents is to be estimated, the receiving apparatus 100 outputs data necessary for printing to a printing apparatus 2100, and the printing apparatus 2100 estimates the printing time, creates corresponding result data, and outputs this data to the receiving apparatus 100.

The receiving apparatus 100 displays printing time data, and prompts a print directive. Then the receiving apparatus 100 outputs a print directive to the printing apparatus 2100, and the printing apparatus 2100 prints print contents corresponding to the content whose printing time was estimated in accordance with the directive.

The communication procedure between the receiving apparatus 100 and printing apparatus 2100 will now be described. FIG. 29 is a sequence diagram showing an example of signal exchange between the receiving apparatus 100 and printing apparatus 2100. In FIG. 29, the communication procedure is described for a case where, when the receiving apparatus 100 prints received contents, the estimated printing time is displayed beforehand in the receiving apparatus 100 and printing is performed after the printing time has been confirmed.

In FIG. 29, the receiving apparatus 100 outputs content to be printed-for example, XML content-from received broadcast contents to the printing apparatus 2100. Here, XML content includes an XML instance and style sheet.

Then the receiving apparatus 100 outputs print job information indicating conditions necessary for printing, such as the printing paper size, resolution, and printing direction, for example, to the printing apparatus 2100.

The printing apparatus 2100 estimates the printing time from the XML content and print job information, and outputs this estimate to the receiving apparatus 100.

The receiving apparatus 100 displays the printing time, and prompts input as to whether or not printing is to be performed. When a directive to perform printing is input, the receiving apparatus 100 outputs a print directive to the printing apparatus2100, and the printing apparatus 2100 prints XML content in accordance with the directive. When XML content and print job information are not stored in the printing apparatus 2100, the receiving apparatus 100 may again output XML content and print job information to the printing apparatus 2100 together with a print directive.

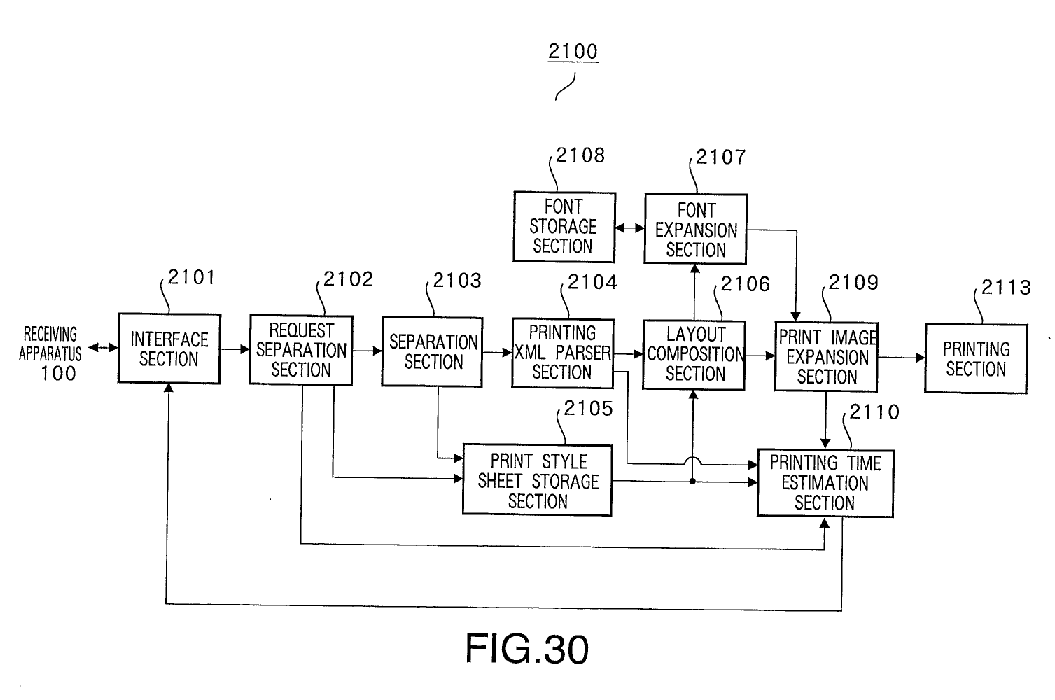

Next, a detailed description of the printing apparatus 2100 will be given. FIG. 30 is a block diagram showing the configuration of a printing apparatus according to Embodiment 10 of the present invention.

In FIG. 30, the printing apparatus 2100 mainly comprises an interface section 2101, request separation section 2102, separation section 2103, printing XML parser section 2104, print style sheet storage section 2105, layout composition section 2106, font expansion section 2107, font storage section 2108, print image expansion section 2109, printing time estimation section 2110, and printing section 2113.

The interface section 2101 receives print data transmitted from the receiving apparatus 100 and outputs that print data to the request separation section 2102.

The request separation section 2102 outputs the print data to the separation section 2103. Then the request separation section 2102 outputs content to be printed and print job information to the printing time estimation section 2110.

The separation section 2103 extracts an XML instance from the print data and outputs this XML instance to the printing XML parser section 2104. The separation section 2103 also extracts a print style sheet or a directive for a print style sheet to be used for printing from the print data and outputs this to the print style sheet storage section 2105.

The printing XML parser section 2104 performs parsing processing on the received XML instance with an XML parser, parses a DTD document and XML document and creates a document object, which it outputs to the layout composition section 2106. This document object is a structured document in which a tree structure is formed in accordance with tags in the original XML document.

The print style sheet storage section 2105 stores a print style sheet, and outputs a print style sheet to be used for printing to the layout composition section 2106 and printing time estimation section 2110 in accordance with a directive output from the separation section 2103. The print style sheet output here by the print style sheet storage section 2105 is determined based on a print directive output from the request separation section 2102.

Using the document object and print style sheet expanded by the printing XML parser section 2104, the layout composition section 2106 outputs XML source to the print image expansion section 2109. The layout composition section 2106 also gives a directive for a font necessary for creation of print image data to the font expansion section 2107.

The font expansion section 2107 refers the font storage section 2108 in accordance with the directive output from the layout composition section 2106, and obtains the necessary font. Then, using the acquired font data, the font expansion section 2107 creates font data of the necessary size in accordance with the directive from the layout composition section 2106, and outputs this font data to the print image expansion section 2109. The font storage section 2108 stores the font data.

The print image expansion section 2109 creates print image data from the XML source and font data, and outputs this print image data to the printing section 2113.

The printing time estimation section 2110 estimates the printing time from the content to be printed, print job information, the print style sheet, and a printer profile, and outputs this estimate to the interface section 2101. Here, the printing time estimation section 2110 stores the printer profile as internal information.

Print job information here includes the printing paper size, printing direction, print resolution, and so forth, and the printer profile includes the font expansion speed, image expansion speed, printer engine profile, and so forth. If the printing apparatus 2100 is an ink-jet printer, the paper feed speed, head movement speed, and so forth, are included in the printer profile.

In this embodiment, “engine” designates the printing section 2113, and indicates the mechanism that prints print image data on paper, etc. The printing section 2113 prints print image data when a print directive is received.

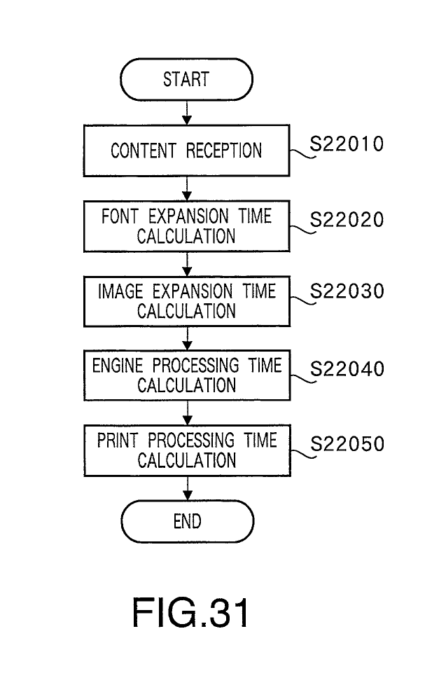

The operation of a printing apparatus of this embodiment will now be described using a flowchart. FIG. 31 is a flowchart showing an example of the operation of a printing apparatus of this embodiment.

In S22010, the interface section 2101 receives XML content and print job information.

In S22020, the printing time estimation section 2110 calculates the font expansion time-that is, the time for expansion of print font data-from the XML content and font expansion speed, using the printing XML parser section 2104.

In S22030, the printing time estimation section 2110 calculates the image expansion time-that is, the time for expansion of print image data-from the XML content and image expansion speed, using the printing XML parser section 2104.

In S22040, the printing time estimation section 2110 calculates the engine processing time, indicating the time for performing printing on printing paper, based on engine performance information. Engine performance information here is information concerning the printing speed of the printing apparatus. For example, engine performance information indicates the head movement speed and paper feed speed of an ink-jet printer or the like, or the printing time per page of a page printer.

In S22050, the print processing time is calculated from the font expansion time, image expansion time, and engine processing time.

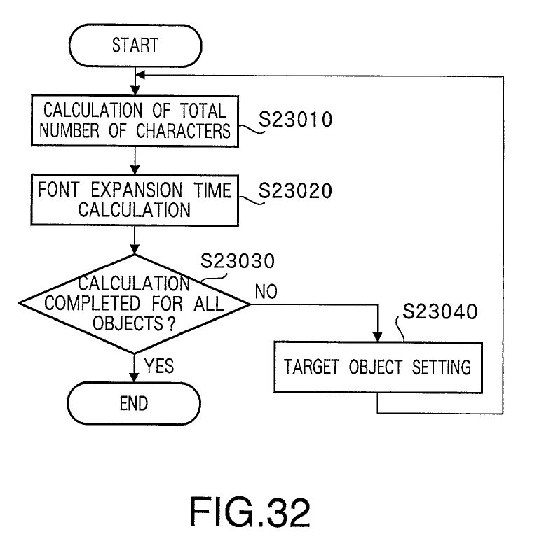

The operations for calculating font expansion time will now be described using a flowchart. FIG. 32 is a flowchart showing an example of the operation of a printing apparatus of this embodiment.

In S23010, the printing XML parser section 2104 calculates the total number of characters subject to font expansion in the XML content.

In S23020, the printing time estimation section 2110 calculates the font expansion time by multiplying the total number of font expansion characters by the font expansion speed.

In S23030, the printing time estimation section 2110 determines whether or not calculation has been completed for all objects. If calculation has been completed for all objects, processing is terminated. If calculation has not been completed for all objects, processing proceeds to S23040.

In S23040, the printing XML parser section 2104 sets the object for which the font expansion time is to be calculated next, and processing returns to S23010.

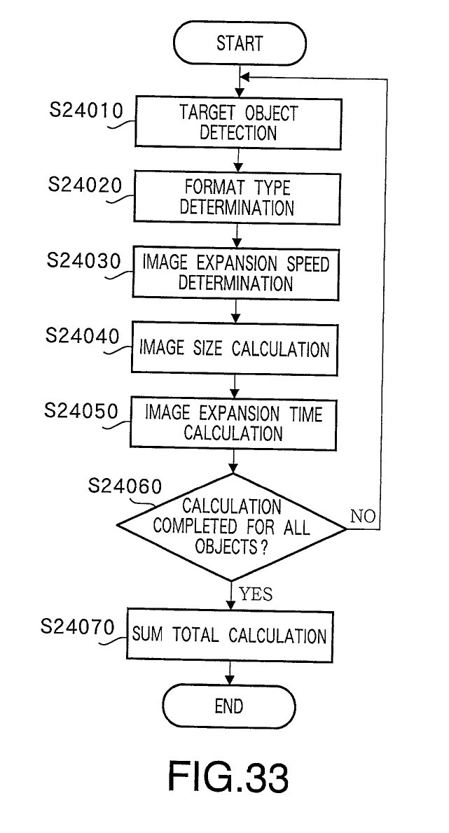

The operations for calculating image expansion time will now be described using a flowchart. FIG. 33 is a flowchart showing an example of the operation of a printing apparatus of this embodiment. The printing time estimation section 2110 calculates the image expansion time for each of the objects for which image expansion is to be performed, and finds the sum total of these image expansion times.

In S24010, the printing XML parser section 2104 looks for an object for which XML content image expansion is to be performed.

In S24020, the printing XML parser section 2104 specifies the image format type from the attribute or file extension of an object for which image expansion is to be performed. Here, determination of the attribute of an object for which image expansion is to be performed is carried out by means of an XML content tag.

In S24030, the printing time estimation section 2110 determines the image expansion speed from the image format type.

In S24040, the printing time estimation section 2110 calculates the image size by multiplying the image width attribute of the image object by its image height attribute.

In S24050, the image expansion time is calculated by multiplying the image expansion speed by the image size.

In S24060, the printing time estimation section 2110 determines whether or not calculation has been completed for all objects. If calculation has been completed for all objects, processing proceeds to S24070. If calculation has not been completed for all objects, processing proceeds to S24010.

In S24070, the printing time estimation section 2110 calculates the sum total of the image expansion times calculated for all the objects, and processing is terminated.

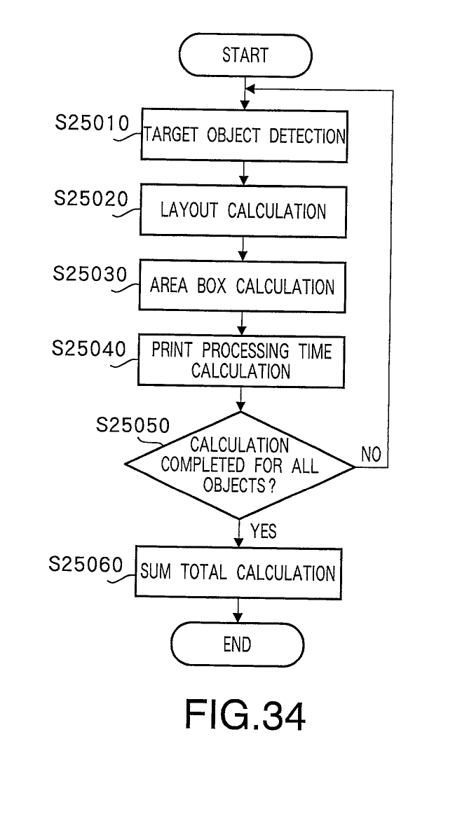

The operations for calculating engine processing time will now be described using a flowchart. FIG. 34 is a flowchart showing an example of the operation of a printing apparatus of this embodiment. FIG. 34 illustrates a case where the printing apparatus 2100 is an ink-jet printer.

With an ink-jet printer, the head is moved to printing coordinates, and ink is sprayed onto the printing surface. Then the head is moved to the next printing coordinates and printing is performed. Thus, by moving the printer head only in an area in which printing is to be performed, and moving the head to the necessary area, it is possible to minimize unnecessary head movement and shorten the printing time.

In S25010, the printing XML parser section 2104 looks for an object for which XML content image expansion is to be performed.

In S25020, the printing XML parser section 2104 specifies the print-time layout from the object for which image expansion is to be performed and the style sheet.

In S25030, the printing time estimation section 2110 calculates the area of the print area box from the calculated layout. The print area box here is the range in which an object is to be printed.

In S25040, the printing time estimation section 2110 calculates the print processing time for each print area box from the area of the print area box, the print-time head movement speed, and the print-time paper feed speed.

In S25050, the printing time estimation section 2110 determines whether or not calculation has been completed for all objects. If calculation has been completed for all objects, processing proceeds to S25060. If calculation has not been completed for all objects, processing returns to S25010.

In S25060, the printing time estimation section 2110 calculates the sum total of the engine processing times calculated for all the objects, and processing is terminated.

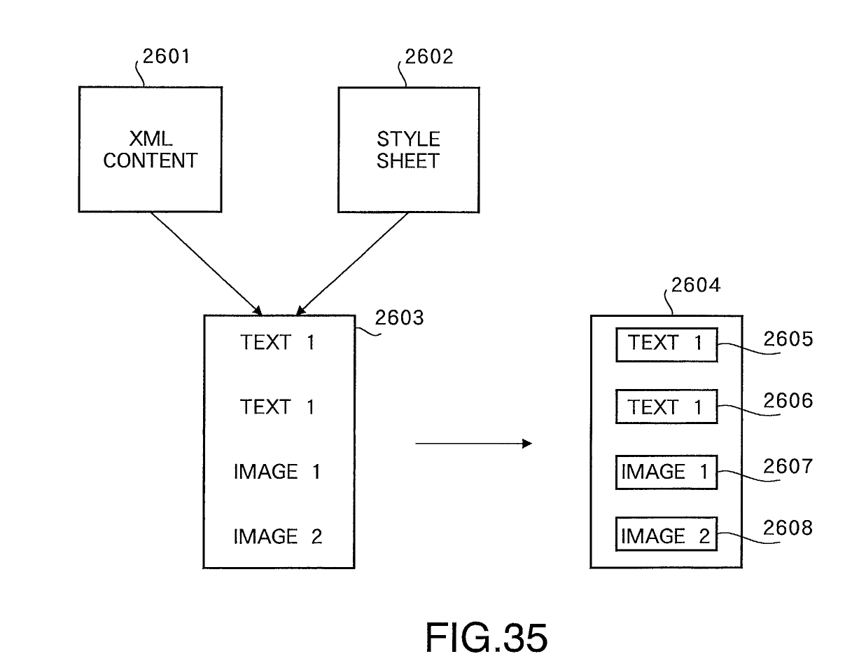

The above-mentioned print area box will now be described. FIG. 35 is a drawing showing a sample print layout.

XML source 2603 containing layout information is created from XML content 2601, using a print style sheet 2602. XML source 2603 is an object in which a plurality of objects, such as texts and images, are arranged in accordance with the style sheet.

Print image data 2604 is created from this XML source 2603. Print image data 2604 is image data composed of a plurality of texts and images. Areas in which data is to be placed are set individually for this plurality of texts and images.

Here, an ink-jet printer example is described for a case where print image data 2604 is composed of text print area box 2605, text print area box 2606, image print area box 2607, and image print area box 2608, and there are no objects for printing in other areas.

With an ink-jet printer, the head is moved to printing coordinates, and ink is sprayed onto the printing surface. Then the head is moved to the next printing coordinates and printing is performed.

Here, printing is performed in the areas of area boxes for performing printing for print image data 2604, and by moving the printer head to the necessary areas and not moving the head to areas other than area boxes, it is possible to minimize unnecessary head movement and shorten the printing time.

In the case of print image data 2604, area boxes are text print area box 2605 and text print area box 2606 indicating areas in which text data is to be printed, and image print area box 2607 and image print area box 2608 indicating areas in which image data is to be printed.

Areas other than these four area boxes have no objects for printing, and there is consequently no need for the head to perform print operations in areas other than these four area boxes.

Thus, the print processing time can be estimated from the sum total of the print processing times for these four area boxes.

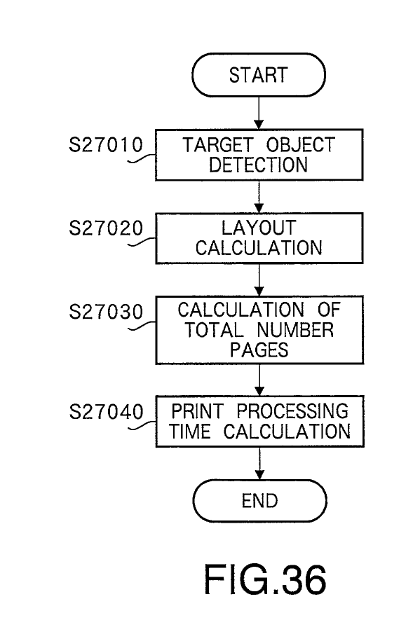

A case where the printing apparatus 2100 is a page printer will now be described, using a flowchart. FIG. 36 is a flowchart showing an example of the operation of a printing apparatus of this embodiment.

A page printer is a printer, such as a laser printer, for example, that performs printing on a page-by-page basis. The time necessary for print processing by a page printer can be estimated from the printing time per page and the number of pages to be printed. The printing time per page is stored as printer engine profile information.

In S27010, the printing XML parser section 2104 looks for an object for which XML content image expansion is to be performed.

In S27020, the printing XML parser section 2104 specifies the print-time layout from the object for which image expansion is to be performed and the style sheet.

In S27030, the printing time estimation section 2110 calculates the total number of pages to be printed from the calculated layout.

In S27040, the printing time estimation section 2110 calculates the print processing time by multiplying the total number of pages by the printing time per page.

Thus, according to a printing apparatus of this embodiment, the time necessary for printing can be ascertained by estimating the total number of pages to be printed and multiplying this number by the printing time per page.

A printing apparatus of this embodiment calculates print processing time from the font expansion time, image expansion time, and engine processing time, but print processing time may also be calculated by using one or a plurality of items of information relating to print processing, such as font expansion time, image expansion time, and engine processing time.

Also, values may be set beforehand for one or a plurality of items of information relating to print processing, such as font expansion time, image expansion time, and engine processing time.

Furthermore, in this embodiment a print style sheet is transmitted from a receiving apparatus to a printing apparatus as one print data item, but it is also possible to store a default print style sheet beforehand in a print style sheet storage section when the receiving apparatus is shipped, and to use that default print style sheet.

(Embodiment 11)

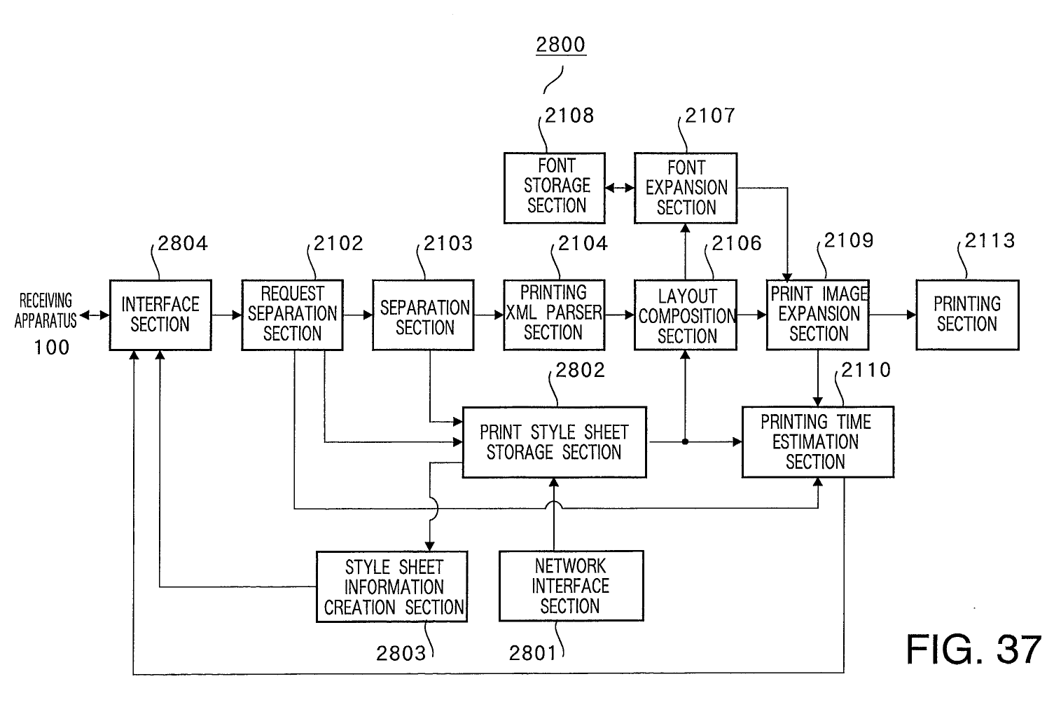

FIG. 37 is a block diagram showing the configuration of a printing apparatus according to Embodiment 11 of the present invention. Parts in FIG. 37 identical to those in FIG. 30 are assigned the same codes as in FIG. 30 and their detailed explanations are omitted.

The printing apparatus 2800 in FIG. 37 differs from the printing apparatus in FIG. 30 in being provided with a network interface section 2801, print style sheet storage section 2802, style sheet information creation section 2803, and interface section 2804, and in that a print style sheet is acquired from an external source, and print style sheet information stored by the printing apparatus is transmitted to a receiving apparatus.

The network interface section 2801 connects to an external network, such as the Internet, for example, obtains print style sheets from the network, and outputs those print style sheets to the print style sheet storage section 2802.

The print style sheet storage section 2802 stores print style sheets and outputs them to a layout composition section 2106 in accordance with a directive output from a separation section 2103. The print style sheet storage section 2802 also outputs information on types of stored print style sheets to the style sheet information creation section 2803.

The style sheet information creation section 2803 converts print style sheet type information to a format that can be displayed by the receiving apparatus 100, such as XML content format, for example, and outputs that information to the interface section 2804.

The interface section 2804 receives print data transmitted from the receiving apparatus 100, and outputs that print data to a request separation section 2102. The interface section 2804 also outputs print style sheet format information output from the style sheet information creation section 2803 to the receiving apparatus 100.

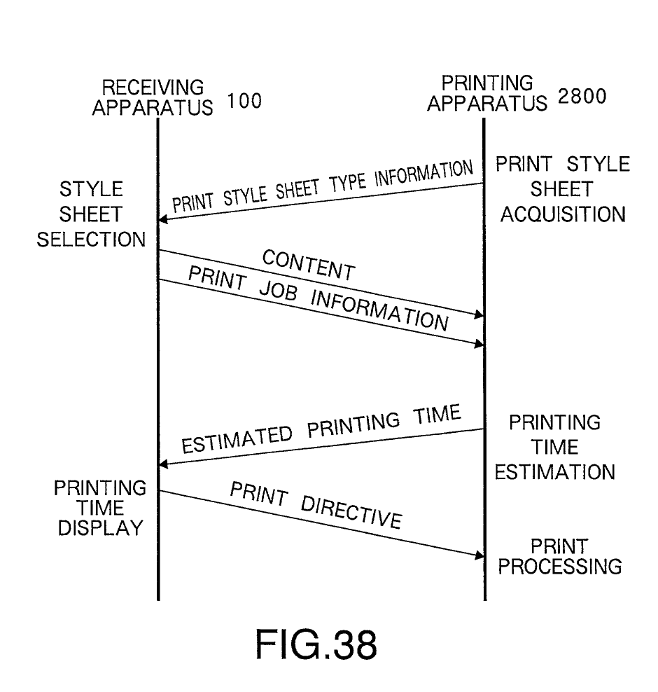

The communication procedure between the receiving apparatus 100 and printing apparatus 2800 will now be described. FIG. 38 is a sequence diagram showing an example of signal exchange between the receiving apparatus 100 and printing apparatus 2800. FIG. 38 illustrates the communication procedure when the printing apparatus 2800 outputs information on print style sheets acquired from an external source to the receiving apparatus 100.

In FIG. 38, the printing apparatus 2800 obtains print style sheets from an external source, and transmits information on types of stored print style sheets to the receiving apparatus 100.

The receiving apparatus 100 displays print style sheet type information, and prompts selection of the print style sheet to be used. The receiving apparatus 100 then outputs content to be printed, such as XML content, for example, from received broadcast content to the printing apparatus 2800. Here, XML content includes an XML instance and style sheet.

Then the receiving apparatus 100 outputs print job information indicating conditions necessary for printing, such as the printing paper size, resolution, and printing direction, for example, and selection information for the print style sheet to be used, to the printing apparatus 2800.

The printing apparatus 2800 estimates the printing time from the XML content and print job information, and outputs this estimate to the receiving apparatus 100.

The receiving apparatus 100 displays the printing time, and prompts input as to whether or not printing is to be performed. When a directive to perform printing is input, the receiving apparatus 100 outputs a print directive to the printing apparatus 2800, and the printing apparatus 2800 prints XML content in accordance with the directive. When XML content and print job information are not stored in the printing apparatus 2800, the receiving apparatus 100 may again output XML content and print job information to the printing apparatus 2800 together with a print directive.

Thus, according to a printing apparatus of this embodiment, it is possible to increase the types of print style sheets used for printing as appropriate by acquiring print style sheets from an external source and transmitting information on print style sheets stored by the printing apparatus to a receiving apparatus.

It is also possible for a removable storage medium to be provided instead of the network interface section 2801, and for print style sheets to be output to the print style sheet storage section 2802 via this storage medium.

(Embodiment 12)

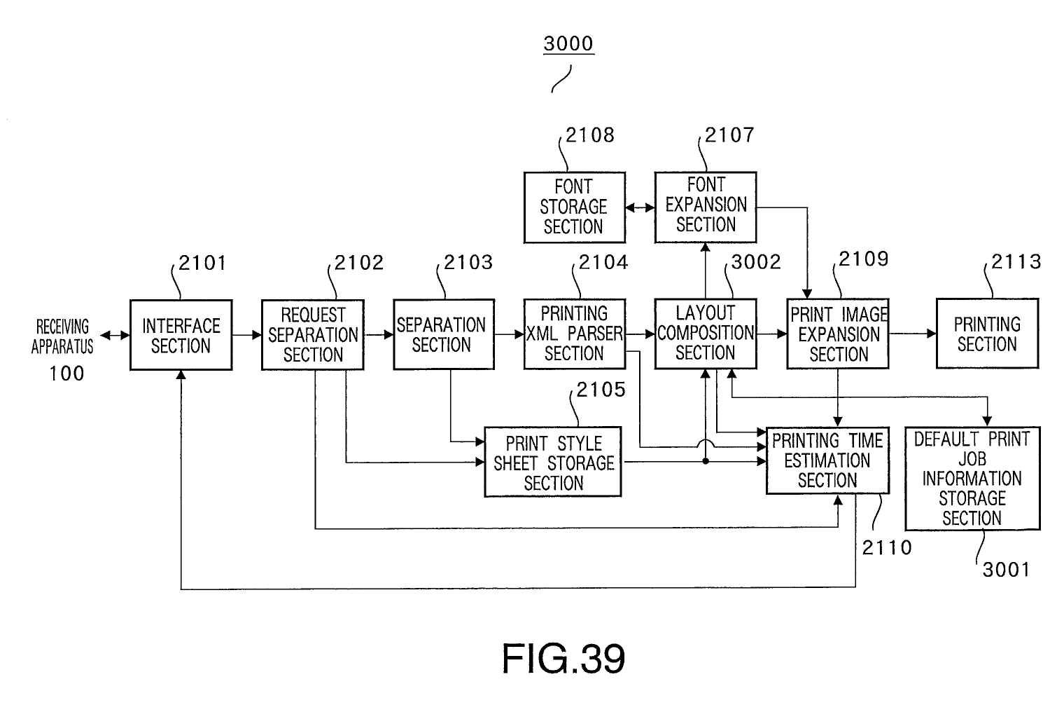

FIG. 39 is a block diagram showing the configuration of a printing apparatus according to Embodiment 12 of the present invention. Parts in FIG. 39 identical to those in FIG. 30 are assigned the same codes as in FIG. 30 and their detailed explanations are omitted.

The printing apparatus 3000 in FIG. 39 differs from the printing apparatus in FIG. 30 in being provided with a default print job information storage section 3001 and layout composition section 3002, and in that default print job information is prepared beforehand, this being print job information used when print job information has not been explicitly specified by a receiving apparatus.

The default print job information storage section 3001 stores default print job information-that is, print job information used when print job information to be used for printing has not been explicitly specified.

Using a document object and print style sheet expanded by a printing XML parser section 2104, the layout composition section 3002 outputs XML source to a print image expansion section 2109. The layout composition section 3002 also gives a directive for a font necessary for creation of print image data to a font expansion section 2107.

If a print style sheet is not output from a print style sheet storage section 2105, the layout composition section 3002 refers to the default style sheet in the default print job information storage section 3001, uses the default style sheet as the print style sheet, and outputs the default style sheet to a printing time estimation section 2110 as the print style sheet.

Thus, according to a printing apparatus of this embodiment, by preparing beforehand default print job information that is used when print job information to be used for printing has not been explicitly specified, it is possible to estimate printing time without print job information being specified by a receiving apparatus, enabling operation to be simplified.

[Printing Cost Estimation]

The gist of the present invention is to estimate the printing cost by referring to the contents and type of an object to be printed, in accordance with the contents of content to be printed.

(Embodiment 13)

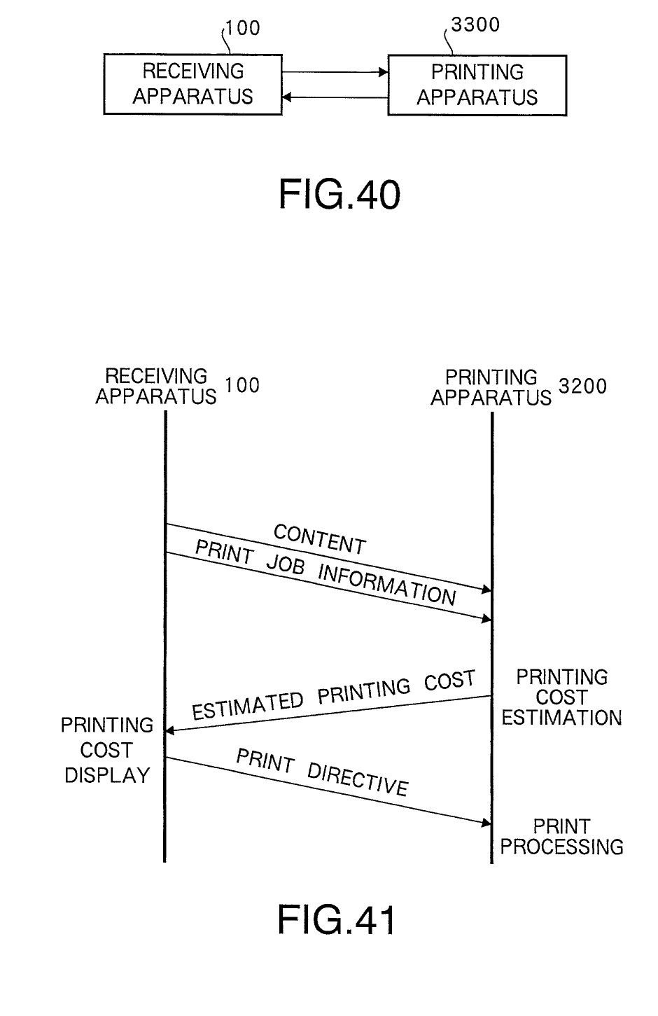

FIG. 40 is a drawing showing the configuration of a receiving apparatus and printing apparatus according to Embodiment 13 of the present invention.

In FIG. 40, a receiving apparatus 100 receives a digital broadcast or similar signal and displays broadcast contents. When broadcast contents are to be printed, the receiving apparatus 100 outputs data necessary for printing to a printing apparatus 3300, and the printing apparatus 3300 estimates the printing cost and outputs this estimate to the receiving apparatus 100.

The receiving apparatus 100 displays the printing cost, and prompts confirmation of the print contents and a print directive. Then the receiving apparatus 100 outputs a print directive to the printing apparatus 3300, and the printing apparatus 3300 prints print contents in accordance with the directive.

The communication procedure between the receiving apparatus 100 and printing apparatus 3300 will now be described. FIG. 41 is a sequence diagram showing an example of signal exchange between the receiving apparatus 100 and printing apparatus 3300. In FIG. 41, the communication procedure is described for a case where, when the receiving apparatus 100 prints received contents, the estimated printing cost is displayed beforehand in the receiving apparatus 100 and printing is performed after the printing cost has been confirmed.

In FIG. 41, the receiving apparatus 100 outputs content to be printed-for example, XML content-from received broadcast contents to the printing apparatus 3300. Here, XML content includes an XML instance and style sheet.

Then the receiving apparatus 100 outputs print job information indicating conditions necessary for printing, such as the printing paper size, resolution, and printing direction, for example, to the printing apparatus 3300.

The printing apparatus 3300 estimates the printing cost from the XML content and print job information, and outputs this estimate to the receiving apparatus 100.

The receiving apparatus 100 displays the printing cost, and prompts input as to whether or not printing is to be performed. When a directive to perform printing is input, the receiving apparatus 100 outputs a print directive to the printing apparatus 3300, and the printing apparatus 3300 prints XML content in accordance with the directive. When XML content and print job information are not stored in the printing apparatus 3300, the receiving apparatus 100 may again output XML content and print job information to the printing apparatus 3300 together with a print directive.

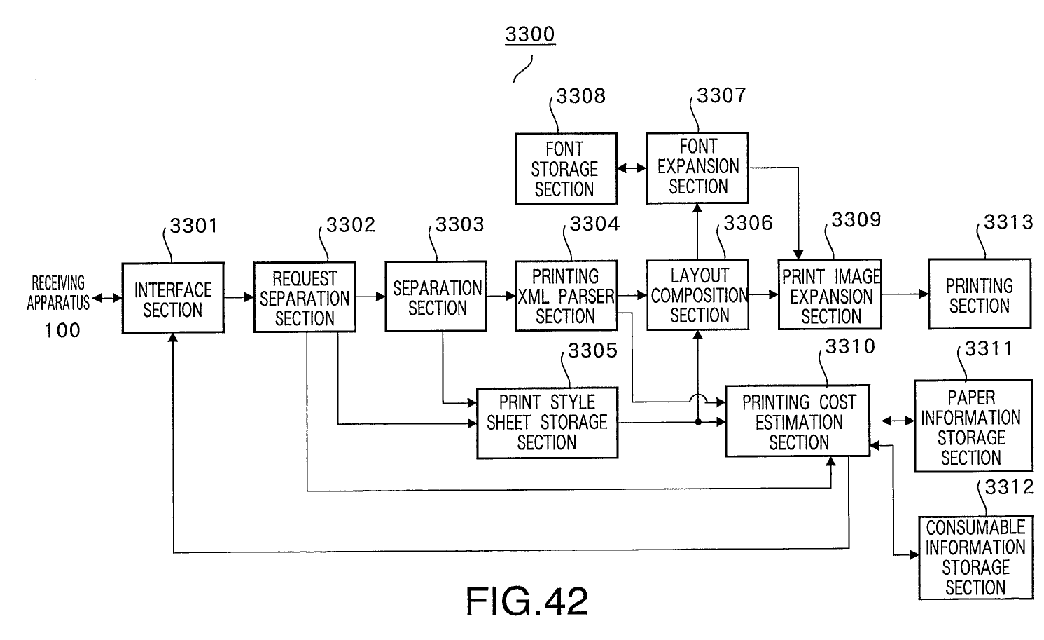

Next, a detailed description of the printing apparatus 3300 will be given. FIG. 42 is a block diagram showing the configuration of a printing apparatus according to Embodiment 13 of the present invention.

In FIG. 42, the printing apparatus 3300 mainly comprises an interface section 3301, request separation section 3302, separation section 3303, printing XML parser section 3304, print style sheet storage section 3305, layout composition section 3306, font expansion section 3307, font storage section 3308, print image expansion section 3309, printing cost estimation section 3310, paper information storage section 3311, consumable information storage section 3312, and printing section 3313.

The interface section 3301 receives print data transmitted from the receiving apparatus 100 and outputs that print data to the request separation section 3302.

The request separation section 3302 outputs the print data to the separation section 3303. Then the request separation section 3302 outputs content to be printed and print job information to the printing cost estimation section 3310.

The separation section 3303 extracts an XML instance from the print data and outputs this XML instance to the printing XML parser section 3304. The separation section 3303 also extracts a print style sheet or a directive for a print style sheet to be used for printing from the print data and outputs this to the print style sheet storage section 3305.

The printing XML parser section 3304 performs parsing processing on the received XML instance with an XML parser, parses a DTD document and XML document and creates a document object, which it outputs to the layout composition section 3306. This document object is a structured document in which a tree structure is formed in accordance with tags in the original XML document.

The print style sheet storage section 3305 stores a print style sheet, and outputs a print style sheet to be used for printing to the layout composition section 3306 and printing cost estimation section 3310 in accordance with a directive output from the separation section 3303. The print style sheet output here by the print style sheet storage section 3305 is determined based on a print directive output from the request separation section 3302.

Using the document object and print style sheet expanded by the printing XML parser section 3304, the layout composition section 3306 outputs XML source to the print image expansion section 3309. The layout composition section 3306 also gives a directive for a font necessary for creation of print image data to the font expansion section 3307.

The font expansion section 3307 refers the font storage section 3308 in accordance with the directive output from the layout composition section 3306, and obtains the necessary font. Then, using the acquired font data, the font expansion section 3307 creates font data of the necessary size in accordance with the directive from the layout composition section 3306, and outputs this font data to the print image expansion section 3309. The font storage section 3308 stores the font data.

The print image expansion section 3309 creates print image data from the XML source and font data, and outputs this print image data to the printing section 3313.

The paper information storage section 3311 stores paper information, which is information such as the cost of the paper to be used for printing. The consumable information storage section 3312 stores consumable information, which is cost information for consumables such as ink or toner used for printing.

The printing cost estimation section 3310 refers the paper information storage section 3311 and obtains information on the paper to be used for printing, and refers the consumable information storage section 3312 and obtains information on consumables to be used for printing. Then the printing cost estimation section 3310 estimates the printing cost from the content to be printed, print job information, the print style sheet, paper information and consumable information, and outputs this estimate to the interface section 3301.

For example, the printing cost estimation section 3310 calculates the printing paper cost, which is one printing cost, by multiplying the printing paper cost per page by the number of print pages. The printing section 3313 prints print image data when a print directive is received.

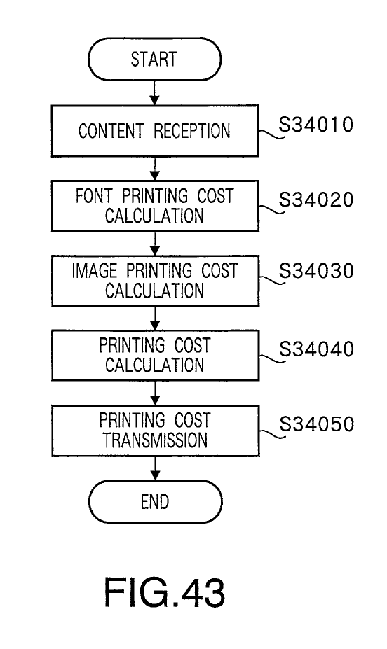

The operation of a printing apparatus of this embodiment will now be described using a flowchart. FIG. 43 is a flowchart showing an example of the operation of a printing apparatus of this embodiment.

In S34010, the interface section 3301 receives XML content and print job information.

In S34020, the printing cost estimation section 3310 calculates the font printing cost from the XML content and font unit printing cost. The font printing cost here indicates the necessary printing cost when printing text according to font type, number of colors, size, and so forth.

In S34030, the printing cost estimation section 3310 calculates the image printing cost from the XML content and the developing material cost per unit area. The image printing cost here indicates the necessary printing cost when printing an image, etc.

In S34040, the printing cost estimation section 3310 calculates the printing cost from the font printing cost and the image printing cost.

In S34050, the interface section 3301 outputs the printing cost to the receiving apparatus 100.

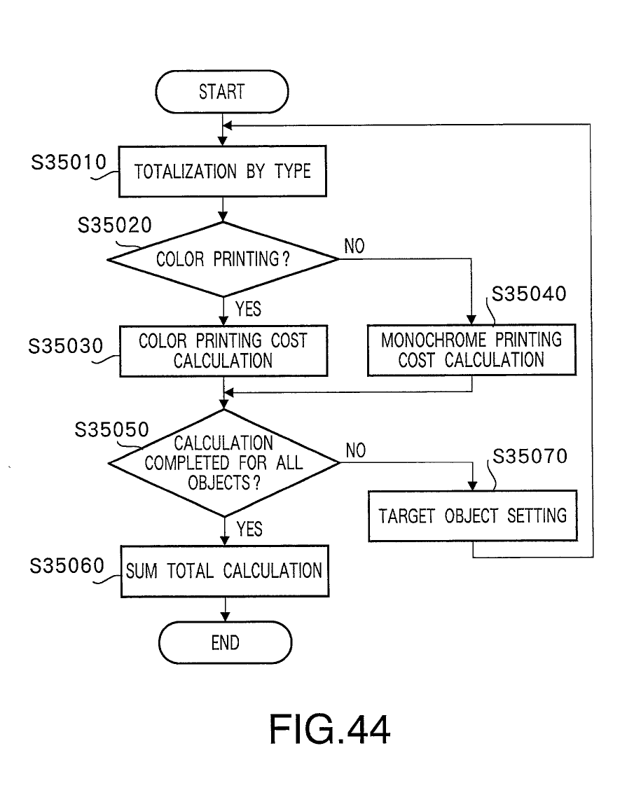

The operations for calculating the font printing cost will now be described using a flowchart. FIG. 44 is a flowchart showing an example of the operation of a printing apparatus of this embodiment.

In S35010, the printing XML parser section 3304 totalizes XML content objects subject to font expansion according to font size and print type. An object subject to font expansion here indicates an object, such as text data, that uses a font among the objects to be printed.

In S35020, the printing cost estimation section 3310 determines whether or not the printing type of an object subject to font expansion is color. If the printing type of an object subject to font expansion is color, processing proceeds to S35030. If the printing type of an object subject to font expansion is not color, but monochrome, processing proceeds to S35040.

In S35030, the font printing cost is calculated for color printing from costs set by font size and by print type, and the number of objects subject to font expansion.

In S35040, the font printing cost is calculated for monochrome printing from costs set by font size and by print type, and the number of objects subject to font expansion.

In S35050, the printing cost estimation section 3310 determines whether or not calculation has been completed for all objects. If calculation has been completed for all objects, processing proceeds to S35060. If calculation has not been completed for all objects, processing proceeds to S35070.

In S35060, the printing cost estimation section 3310 calculates the sum total of printing costs calculated for all objects, and processing is terminated.

In S35070, the printing XML parser section 3304 sets the object for which the printing cost is to be calculated next, and processing returns to S35010.

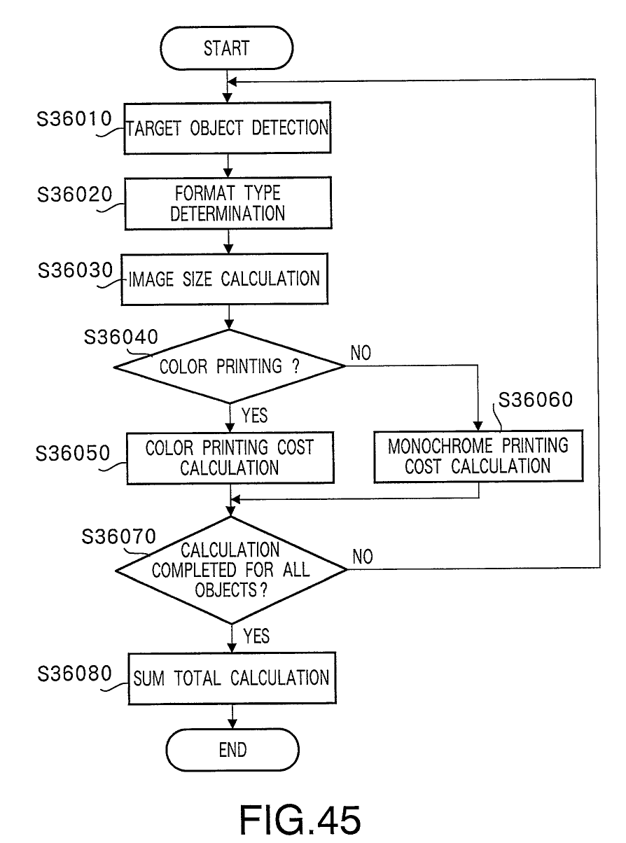

The operations for calculating image expansion cost will now be described using a flowchart. FIG. 45 is a flowchart showing an example of the operation of a printing apparatus of this embodiment. The printing cost estimation section 3310 calculates the printing cost for each of the objects for which image expansion is to be performed, and finds the sum total of these printing costs .

In S36010, the printing XML parser section 3304 looks for an object for which XML content image expansion is to be performed.

In S36020, the printing XML parser section 3304 specifies the image format type from the attribute or file extension of an object for which image expansion is to be performed. Here, determination of the attribute of an object for which image expansion is to be performed is carried out by means of an XML content tag.

In S36030, the printing cost estimation section 3310 calculates the image size by multiplying the image width attribute of the image object by its image height attribute.

In S36040, the printing cost estimation section 3310 determines whether or not the printing type of an object of font expansion is color. If the printing type of an object of font expansion is color, processing proceeds to S36050. If the printing type of an object of font expansion is not color, but monochrome, processing proceeds to S36060.

In S36050, the image printing cost is calculated for color printing by multiplying the image size by the color developing material cost per unit area.

In S36060, the image printing cost is calculated for monochrome printing by multiplying the image size by the monochrome developing material cost per unit area.

In S36070, the printing cost estimation section 3310 determines whether or not calculation has been completed for all objects. If calculation has been completed for all objects, processing proceeds to S36080. If calculation has not been completed for all objects, processing returns to S36010.

In S36060, the printing cost estimation section 3310 calculates the sum total of the printing costs calculated for all the objects, and processing is terminated.

Thus, according to a printing apparatus of this embodiment, the cost necessary for printing can be ascertained by making an estimate after referring to the contents and type of objects to be printed in accordance with the contents of content to be printed.

(Embodiment 14)

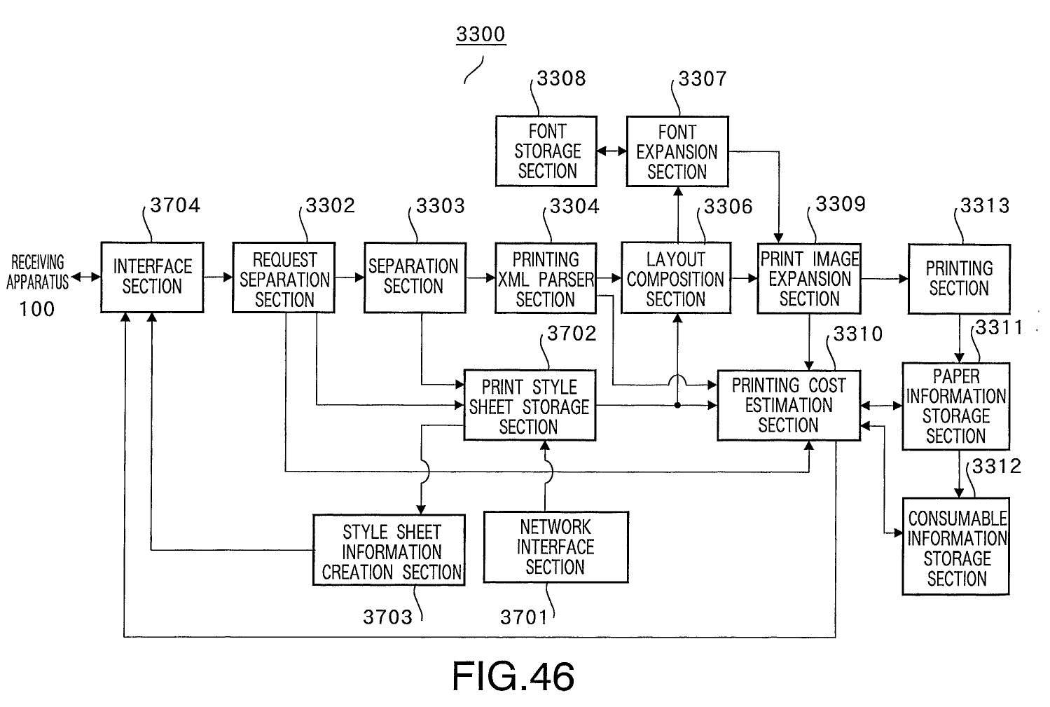

FIG. 46 is a block diagram showing the configuration of a printing apparatus according to Embodiment 14 of the present invention. Parts in FIG. 46 identical to those in FIG. 42 are assigned the same codes as in FIG. 42 and their detailed explanations are omitted.

The printing apparatus 3700 in FIG. 46 differs from the printing apparatus in FIG. 42 in being provided with a network interface section 3701, print style sheet storage section 3702, style sheet information creation section 3703, and interface section 3704, and in that a print style sheet is acquired from an external source, and print style sheet information stored by the printing apparatus is transmitted to a receiving apparatus.

The network interface section 3701 connects to an external network, such as the Internet, for example, obtains print style sheets from the network, and outputs those print style sheets to the print style sheet storage section 3702.

The print style sheet storage section 3702 stores print style sheets and outputs them to a layout composition section 3306 in accordance with a directive output from a separation section 3303. The print style sheet storage section 3702 also outputs information on types of stored print style sheets to the style sheet information creation section 3703.

The style sheet information creation section 3703 converts print style sheet type information to a format that can be displayed by the receiving apparatus 100, such as XML content format, for example, and outputs that information to the interface section 3704.

The interface section 3704 receives print data transmitted from the receiving apparatus 100, and outputs that print data to a request separation section 3302. The interface section 3704 also outputs print style sheet format information output from the style sheet information creation section 3703 to the receiving apparatus 100.

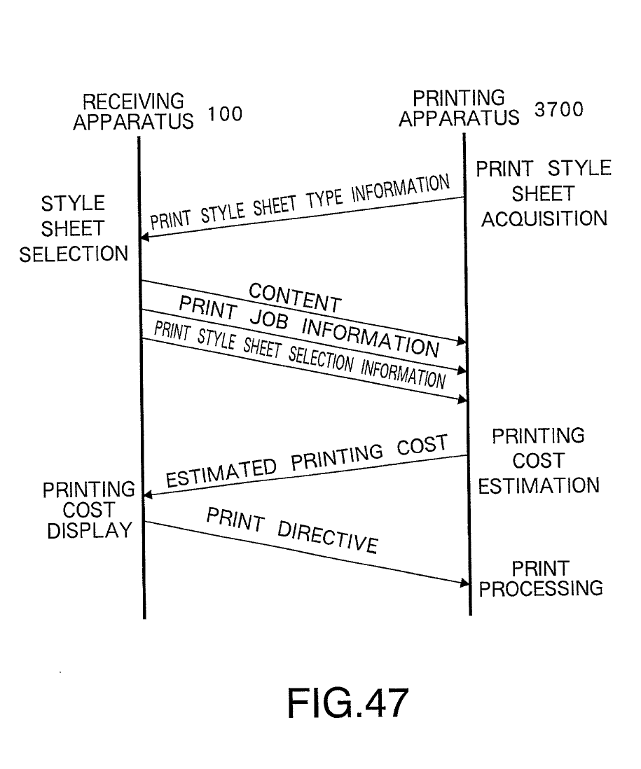

The communication procedure between the receiving apparatus 100 and printing apparatus 3700 will now be described. FIG. 47 is a sequence diagram showing an example of signal exchange between the receiving apparatus 100 and printing apparatus 3700. FIG. 47 illustrates the communication procedure when the printing apparatus 3700 outputs information on print style sheets acquired from an external source to the receiving apparatus 100.

In FIG. 47, the printing apparatus 3700 obtains print style sheets from an external source, and transmits information on types of stored print style sheets to the receiving apparatus 100.

The receiving apparatus 100 displays print style sheet type information, and prompts selection of the print style sheet to be used. The receiving apparatus 100 then outputs content to be printed, such as XML content, for example, from received broadcast content to the printing apparatus 3700. Here, XML content includes an XML instance and style sheet.

Then the receiving apparatus 100 outputs print job information indicating conditions necessary for printing, such as the printing paper size, resolution, and printing direction, for example, and selection information for the print style sheet to be used, to the printing apparatus 3700.

The printing apparatus 3700 estimates the printing cost from the XML content and print job information, and outputs this estimate to the receiving apparatus 100.

The receiving apparatus 100 displays the printing cost, and prompts input as to whether or not printing is to be performed. When a directive to perform printing is input, the receiving apparatus 100 outputs a print directive to the printing apparatus 3700, and the printing apparatus 3700 prints XML content in accordance with the directive. When XML content and print job information are not stored in the printing apparatus 3700, the receiving apparatus 100 may again output XML content and print job information to the printing apparatus 3700 together with a print directive.

Thus, according to a printing apparatus of this embodiment, it is possible to increase the types of print style sheets used for printing as appropriate by acquiring print style sheets from an external source and transmitting information on print style sheets stored by the printing apparatus to a receiving apparatus.

It is also possible for a removable storage medium to be provided instead of the network interface section 3701, and for print style sheets to be output to the print style sheet storage section 3702 via this storage medium.

(Embodiment 15)

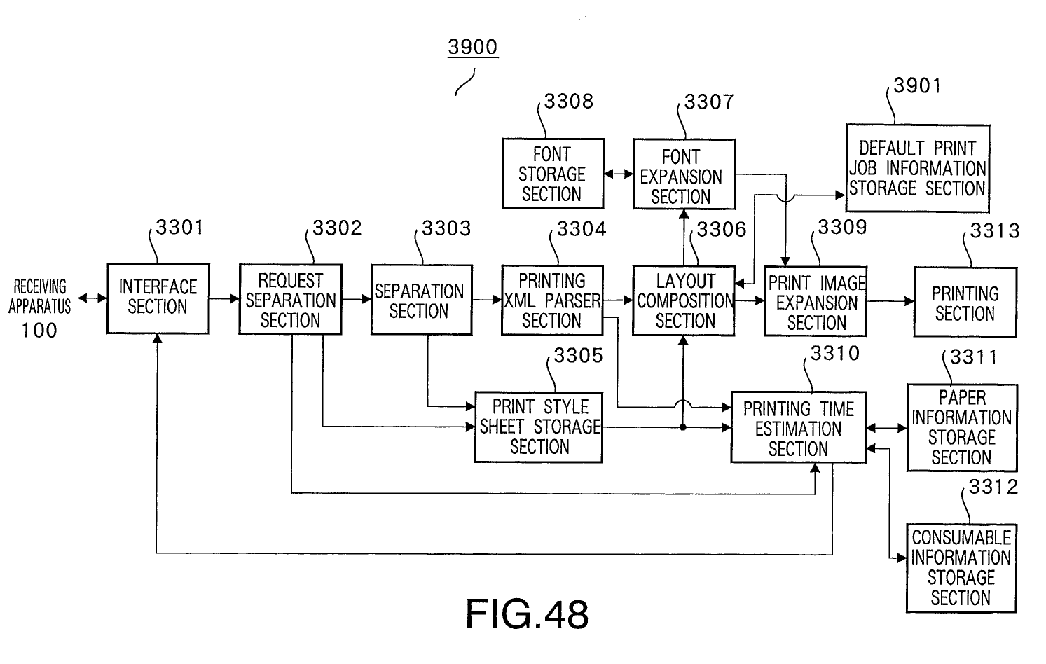

FIG. 48 is a block diagram showing the configuration of a printing apparatus according to Embodiment 15 of the present invention. Parts in FIG. 48 identical to those in FIG. 42 are assigned the same codes as in FIG. 42 and their detailed explanations are omitted.

The printing apparatus 3900 in FIG. 48 differs from the printing apparatus in FIG. 42 in being provided with a default print job information storage section 3901 and layout composition section 3902, and in that default print job information is prepared beforehand, this being print job information used when print job information to be used for printing has not been explicitly specified.

The default print job information storage section 3901 stores default print job information-that is, print job information used when print job information to be used for printing has not been explicitly specified.

Using a document object and print style sheet expanded by a printing XML parser section 3304, the layout composition section 3902 outputs XML source to a print image expansion section 3309. The layout composition section 3902 also gives a directive for a font necessary for creation of print image data to a font expansion section 3307.

Thus, according to a printing apparatus of this embodiment, by preparing beforehand default print job information that is used when print job information to be used for printing has not been explicitly specified, it is possible to estimate the printing cost without print job information being specified by a receiving apparatus, enabling operation to be simplified.

In the above implementation examples, printing of content represented by means of XML language has been described, but the present invention can be applied as long as content uses a print style sheet that stipulates a print output format relating to data composed by means of instructions of a computer language having a data attribute, and more particularly data composed by means of instructions of a computer language having a data attribute.

Also, in the above implementation examples, printing of content represented by means of XML language has been described, but the present invention can also be applied to any content expressed using a markup language or the like.

For example, the present invention can be applied to markup language format data written in a markup language that uses tags, digital broadcasting content output from a digital broadcast receiver, Internet content output from a mobile phone, Internet content output from an Internet terminal, and so forth.

The present invention is not limited to the above-described embodiments, and various variations and modifications may be possible without departing from the scope of the present invention. For example, in the above embodiments a case has been described in which the present invention is implemented using a printing apparatus, but this is not a limitation, and it is also possible to for this pre-printing information estimation method to be implemented in the form of software.

For example, it is possible for a program that executes the above pre-printing information estimation method to be stored beforehand in ROM (Read Only Memory), and for that program to be run by a CPU (Central Processing Unit).

Furthermore, it is also possible for a program that executes the above pre-printing information estimation method to be stored on a computer-readable storage medium, and for the program stored on the storage medium to be recorded in the RAM (Random Access Memory) of a computer, and the computer to be operated in accordance with that program.

A printing apparatus of the present invention employs a configuration that has a preview data creation section that creates preview data for print preview use from print data for printing use, and a transmitting section that transmits created preview data.

According to this configuration, it is possible to confirm print contents with a display apparatus prior to printing from a printing apparatus by converting print image data based on the display capability of the display apparatus, and creating preview data.

A printing apparatus of the present invention employs a configuration wherein, in the above-described configuration, the preview data creation section creates preview data by converting the resolution of print data based on preview screen information and the number of print pixels.

A printing apparatus of the present invention employs a configuration wherein, in the above-described configuration, the preview screen information is the number of effective preview area pixels of the preview screen, and the preview data creation section has a section that calculates the number of print pixels corresponding to one page of print data based on printing condition information including at least the printing paper size, printing direction, and print resolution when printing print data, a section that calculates a print data resolution conversion ratio, based on the number of effective preview area pixels of the preview screen and the calculated number of print pixels corresponding to one page of print data, so that a print image area corresponding to one page of print data fits into the preview area of the preview screen, and a section that creates preview data by converting the resolution of print data based on the calculated resolution conversion ratio.

A printing apparatus of the present invention employs a configuration wherein, in the above-described configuration, the preview screen information is composed of the number of horizontal pixels and the number of vertical pixels, the number of print pixels is composed of the number of horizontal pixels and the number of vertical pixels, and the resolution conversion ratio is calculated based on the preview screen information and the number of pixels in the direction for which conversion is more necessary of horizontal pixels and vertical pixels in the print pixels.

According to these configurations, an entire page of print data can be displayed on the preview screen of a receiving apparatus.

A printing apparatus of the present invention employs a configuration wherein, in the above-described configuration, a default printing condition information storage section that stores default printing condition information, and a determining section that determines whether or not printing condition information has been conveyed, are further provided, and when printing condition information has not been conveyed, the preview data creation section uses default printing condition information stored by the default printing condition information storage section as printing condition information to be used when converting the resolution of print data.

According to this configuration, by preparing beforehand default print condition information, which is printing condition information that is used when print condition information has not been explicitly specified by a display apparatus, it is possible to create preview data even when print condition information is not specified.

A printing apparatus of the present invention employs a configuration wherein, in the above-described configuration, a style sheet storage section that stores a print style sheet that stipulates a print output format relating to data composed by means of instructions of a computer language having a data attribute, a receiving section that receives data composed by means of instructions of a computer language having a data attribute, and a print data creation section that creates print data from received data based on a print style sheet stored in the style sheet storage section, are further provided, and the preview data creation section creates preview data for print preview use from created print data.

According to this configuration, it is possible to confirm print contents with a display apparatus prior to printing data that uses a style sheet.

A printing apparatus of the present invention employs a configuration wherein, in the above-described configuration, the preview data creation section creates preview data for print preview use by performing rasterization processing of print data.

A printing apparatus of the present invention employs a configuration wherein, in the above-described configuration, the preview data creation section calculates the number of preview data pixels based on preview screen information and the number of print pixels, and creates preview data corresponding to the number of preview data pixels by performing rasterization processing of print data.

A printing apparatus of the present invention employs a configuration wherein, in the above-described configuration, the preview screen information is the number of effective preview area pixels of the preview screen, and the preview data creation section has a section that calculates the number of print pixels corresponding to one page of print data based on printing condition information including at least the printing paper size, printing direction, and print resolution when printing print data, a section that calculates a resolution conversion ratio, based on the number of effective preview area pixels of the preview screen and the calculated number of print pixels corresponding to one page of print data, so that a print image area corresponding to one page of print data fits into the preview area of the preview screen, and a section that calculates the number of preview data pixels from the calculated resolution conversion ratio and number of print pixels, and creates preview data by performing rasterization processing of print data based on the calculated number of preview data pixels.

A printing apparatus of the present invention employs a configuration wherein, in the above-described configuration, the preview screen information is composed of the number of horizontal pixels and the number of vertical pixels, the number of print pixels is composed of the number of horizontal pixels and the number of vertical pixels, and the resolution conversion ratio is calculated based on the preview screen information and the number of pixels in the direction for which conversion is more necessary of horizontal pixels and vertical pixels in the print pixels.

A printing apparatus of the present invention employs a configuration wherein, in the above-described configuration, the preview data creation section calculates a preview image display layout based on the number of preview data pixels to be displayed, and creates preview data by performing rasterization processing of print data based on the number of preview data pixels and the display layout.

According to these configurations, it is possible to confirm print contents with a display apparatus prior to printing from a printing apparatus by calculating the display layout of a preview image based on the number of preview data pixels to be displayed, and creating preview data by performing rasterization processing of print data based on the number of preview data pixels and the display layout. Also, according to these configurations, since preview data is generated directly without generating a print image, a memory area for temporary storage of a print image is not necessary, and moreover, a smaller memory area is necessary, and lower image processing capability is necessary, than with a normal method of generating a print image that requires a high degree of processing capability.

A printing apparatus of the present invention employs a configuration wherein, in the above-described configuration, the preview data creation section is characterized by calculating a print image layout based on the number of print image pixels, and creating preview data by performing rasterization processing of print data based on the number of preview data pixels and the print image layout.

According to this configuration, it is possible to confirm print contents with a display apparatus prior to printing from a printing apparatus by calculating a print image layout based on the number of print image pixels, and creating preview data by performing rasterization processing of print data based on the number of preview data pixels and the print image layout. Also, according to this configuration, it is possible to display a preview image closely resembling a print image by creating preview data layout information from print image layout information.

A printing apparatus of the present invention employs a configuration wherein, in the above-described configuration, a style sheet storage section that stores a print style sheet that stipulates a print output format relating to data composed by means of instructions of a computer language having a data attribute, a receiving section that receives data composed by means of instructions of a computer language having a data attribute, and a print data creation section that creates print data from received data based on a print style sheet stored in the style sheet storage section, are further provided, and the preview data creation section creates preview data for print preview use from created print data.

According to this configuration, it is possible to confirm print contents with a display apparatus prior to printing data that uses a style sheet.

A printing apparatus of the present invention employs a configuration wherein, in the above-described configuration, the data composed by means of instructions of a computer language having a data attribute is markup language format data written in a markup language that uses tags. A printing apparatus of the present invention employs a configuration wherein, in the above-described configuration, the print data is markup language format data written in a markup language that uses tags.

According to these configurations, it is possible to confirm print contents with a display apparatus prior to printing data that uses a markup language.

A printing apparatus of the present invention employs a configuration wherein, in the above-described configuration, the markup language format data is digital broadcasting content output from a digital broadcast receiver.

According to this configuration, it is possible to confirm print contents with a display apparatus prior to printing digital broadcasting content output from a digital broadcast receiver.

A printing apparatus of the present invention employs a configuration wherein, in the above-described configuration, the markup language format data is Internet content output from a mobile phone.

According to this configuration, it is possible to confirm print contents with a display apparatus prior to printing Internet content output from a mobile phone.

A printing apparatus of the present invention employs a configuration wherein, in the above-described configuration, the markup language format data is Internet content output from an Internet terminal.

According to this configuration, it is possible to confirm print contents with a display apparatus prior to printing Internet content output from an Internet terminal.

A printing apparatus of the present invention employs a configuration wherein, in the above-described configuration, the style sheet storage section stores a plurality of print style sheets, and the print data creation section creates print data from received data based on a print style sheet selected from the plurality of print style sheets stored in the style sheet storage section.

A printing apparatus of the present invention employs a configuration wherein, in the above-described configuration, an acquisition section that acquires a print style sheet is further provided, and the style sheet storage section stores an acquired print style sheet.

According to these configurations, it is possible to increase the types of print style sheets used for printing as appropriate by acquiring print style sheets from an external source and transmitting information on print style sheets stored by a printing apparatus to a receiving apparatus.

A printing apparatus of the present invention employs a configuration wherein, in the above-described configuration, a print data storage section that stores print data used when creating preview data, and a control section that causes print data stored in the print data storage section to be printed when a print directive is input after transmission of created preview data, are further provided.

According to this configuration, by temporarily storing created print image data and printing using temporarily stored print image data when there is a print directive after preview output, it is sufficient for print image data to be created only at the time of preview data creation, thereby enabling processing time when printing to be shortened.

A printing apparatus of the present invention employs a configuration wherein, in the above-described configuration, the preview data creation section creates one page of preview data from one page of print data each time a preview directive is input, and the transmitting section transmits one created page of preview data.

According to this configuration, by creating preview images on a page-by-page basis in accordance with directives from a receiving apparatus, it is possible to create preview data in a shorter time than that for creating all preview data, and the time until the first page of a preview is displayed can be shortened when printing a plurality of pages.

A printing apparatus of the present invention employs a configuration wherein, in the above-described configuration, a determining section that determines the presence or absence of a next page based on page information is further provided, and the transmitting section transmits information on the presence or absence of a next page together with one created page of preview data.

According to this configuration, by counting the number of pages for which preview data is created and determining whether or not all the pages of preview data to be printed have been created, it is possible to confirm whether or not preview data has been created up to the end of the content to be printed when creating preview data on a page-by-page basis.

A printing apparatus of the present invention employs a configuration wherein, in the above-described configuration, the preview data creation section creates all pages of preview data from print data, and the transmitting section transmits one page of preview data sequentially from all the pages of preview data created each time a preview directive is input.

According to this configuration, by creating and storing all pages of preview data and displaying that data on a page-by-page basis in accordance with directives from a receiving apparatus, preview data creation is not necessary in the case of a preview directive from the second page onward, enabling the time until a preview is displayed to be shortened.

A printing apparatus of the present invention employs a configuration wherein, in the above-described configuration, a detecting section that detects the total number of pages of preview data created is further provided, and the transmitting section, when transmitting the first page of preview data, transmits information as to the detected total number of pages together with that first page of preview data.

According to this configuration, it is possible to ascertain the number of pages to be printed.

A printing apparatus of the present invention employs a configuration wherein, in the above-described configuration, a detecting section that detects the total number of pages of preview data created, and a counting section that calculates the remaining number of untransmitted pages by subtracting the number of transmitted pages from the detected total number of pages, are further provided, and the transmitting section, when transmitting one page of preview data, transmits acquired information as to the remaining number of pages together with that one page of preview data.

A printing apparatus of the present invention employs a configuration wherein, in the above-described configuration, a calculating section that calculates the number of pages that can be displayed on the preview screen at one time based on preview screen information and printing condition information is further provided, and the preview data creation section creates that displayable number of pages of preview data from the calculated displayable number of pages of print data, and the transmitting section simultaneously transmits the created displayable number of pages of preview data.

According to these configurations, it is possible to display a plurality of preview pages on the preview screen by creating preview data for every number of pages that can be displayed on the preview screen at one time based on preview screen information and printing condition information.

A printing apparatus of the present invention employs a configuration wherein, in the above-described configuration, a style sheet storage section that stores a print style sheet that stipulates a print output format relating to data composed by means of instructions of a computer language having a data attribute, a receiving section that receives data composed by means of instructions of a computer language having a data attribute, and a print data creation section that creates a calculated displayable number of pages of print data from received data based on a print style sheet stored in the style sheet storage section, are further provided.

A data processing method of the present invention is a data processing method in a printing apparatus, and has a step of creating preview data for print preview use from print data for printing use, and a step of transmitting created preview data.

A data processing program of the present invention is a data processing program in a printing apparatus, and has a step of creating preview data for print preview use from print data for printing use, and a step of transmitting created preview data.

A printing system of the present invention is a printing system that has a client device that receives data composed by means of instructions of a computer language having a data attribute, and a printing apparatus connected to the client device, wherein the printing apparatus has a section that stores a print style sheet that stipulates a print output format relating to data composed by means of instructions of a computer language having a data attribute, a section that receives data composed by means of instructions of a computer language having a data attribute from the client device, a section that creates print data for printing use from received data based on a print style sheet stored in that printing apparatus, a section that creates preview data for print preview use by converting the resolution of created print data based on preview screen information and printing condition information, and a section that transmits created preview data to the client device, and the client device has a section that receives preview data transmitted from the printing apparatus, and a section that displays received preview data on a screen.

According to these configurations, it is possible to confirm print contents with a display apparatus prior to printing from a printing apparatus by converting print image data based on the display capability of the display apparatus, and creating preview data.

A print preview method of the present invention is a print preview method in a printing system that has a client device that receives data composed by means of instructions of a computer language having a data attribute, and a printing apparatus connected to the client device, that print preview method having a step whereby the printing apparatus receives data composed by means of instructions of a computer language having a data attribute from the client device, a step whereby the printing apparatus creates print data for printing use from received data based on a print style sheet that stipulates a print output format relating to data composed by means of instructions of a computer language having a data attribute stored in that printing apparatus, a step whereby the printing apparatus creates preview data for print preview use by converting the resolution of created print data based on preview screen information and printing condition information, a step whereby the printing apparatus transmits created preview data to the client device, a step whereby the client device receives preview data transmitted from the printing apparatus, and a step whereby the client device displays received preview data on a screen.

According to this configuration, it is possible to confirm print contents with a display apparatus prior to printing from a printing apparatus by converting print image data based on the display capability of the display apparatus, and creating preview data.

A printing apparatus of the present invention employs a configuration that has a printing time estimation section that estimates the printing time of data composed by means of instructions of a computer language having a data attribute, and a transmitting section that transmits the estimated printing time.

A printing apparatus of the present invention employs a configuration wherein, in the above-described configuration, the printing time estimation section calculates at least one time from among font expansion time, image expansion time, and engine processing time, and estimates the printing time by totalizing the calculated times.

A printing apparatus of the present invention employs a configuration wherein, in the above-described configuration, the font expansion time is calculated based on font expansion speed information for that printing apparatus.

A printing apparatus of the present invention employs a configuration wherein, in the above-described configuration, the font expansion time is calculated by multiplying the font expansion speed of that printing apparatus by the total number of characters subject to font expansion contained in the data.

A printing apparatus of the present invention employs a configuration wherein, in the above-described configuration, the image expansion time is calculated based on image expansion speed information for that printing apparatus.

A printing apparatus of the present invention employs a configuration wherein, in the above-described configuration, the image expansion time is calculated by multiplying the image expansion speed of that printing apparatus by the size of the total area subject to image expansion contained in the data.

A printing apparatus of the present invention employs a configuration wherein, in the above-described configuration, the engine processing time is calculated based on engine performance information for that printing apparatus, a print style sheet that stipulates a print output format relating to data composed by means of instructions of a computer language having a data attribute, and the data composed by means of instructions of a computer language having a data attribute.

According to these configurations, it is possible to ascertain the time necessary for printing by estimating the time necessary for printing on an object-by-object basis for content to be printed, and finding the sum total of the printing times for all objects to be printed.

A printing apparatus of the present invention employs a configuration wherein, in the above-described configuration, the engine performance information is selected based on printing condition information including at least the printing paper size, printing direction, and print resolution when printing print data.

According to this configuration, it is possible to ascertain the printing time according to the printing conditions of a printing apparatus.

A printing apparatus of the present invention employs a configuration wherein, in the above-described configuration, when printing is performed while moving a print-head, the engine processing time is calculated based on a print area box calculated based on a print style sheet, and the head movement speed and paper feed speed of that printing apparatus.

According to this configuration, it is possible to ascertain the printing time of a printing apparatus, such as an ink-jet printer, in which a head is moved.

A printing apparatus of the present invention employs a configuration wherein, in the above-described configuration, when printing is performed while moving a print-head, the path of movement of the print-head is calculated based on printing condition information including at least the printing paper size, printing direction, and print resolution when printing print data, and the engine processing time is calculated based on the obtained path of movement and the head movement speed of that printing apparatus.

According to this configuration, it is possible to ascertain the printing time according to the printing conditions of a printing apparatus.

A printing apparatus of the present invention employs a configuration wherein, in the above-described configuration, when printing is performed on a page-by-page basis, the engine processing time is calculated based on the total number of pages calculated based on a print style sheet, and the printing time per page of that printing apparatus.

According to this configuration, it is possible to ascertain the printing time of a printing apparatus such as a page printer.

A printing apparatus of the present invention employs a configuration wherein, in the above-described configuration, a style sheet storage section that stores a plurality of print style sheets is further provided, and the printing time estimation section, when calculating the engine processing time, performs engine processing time calculation based on engine performance information for that printing apparatus, a print style sheet selected from the plurality of print style sheets stored in the style sheet storage section, and the data composed by means of instructions of a computer language having a data attribute.

A printing apparatus of the present invention employs a configuration wherein, in the above-described configuration, an acquisition section that acquires a print style sheet and a style sheet storage section that stores an acquired style sheet are further provided, and the printing time estimation section, when calculating the engine processing time, performs engine processing time calculation based on engine performance information for that printing apparatus, a print style sheet stored in the style sheet storage section, and the data composed by means of instructions of a computer language having a data attribute.

According to these configurations, it is possible to increase the types of print style sheets used for printing as appropriate by acquiring print style sheets from an external source and transmitting information on print style sheets stored by a printing apparatus to a receiving apparatus.

A printing apparatus of the present invention employs a configuration wherein, in the above-described configuration, the engine processing time is a set value.

According to this configuration, it is possible to calculate the printing time with little processing.

A printing apparatus of the present invention employs a configuration wherein, in the above-described configuration, a default printing condition information storage section that stores default printing condition information, and a determining section that determines whether or not printing condition information has been conveyed, are further provided, and, when printing condition information has not been conveyed, the printing time estimation section uses default printing condition information stored in the default printing condition information storage section as printing condition information to be used when estimating the printing time.

According to this configuration, by preparing beforehand default print condition information, which is printing condition information that is used when print condition information has not been explicitly specified by a display apparatus, it is possible to create printing time information according to printing conditions even when print condition information is not specified.

A data processing method of the present invention is a data processing method in a printing apparatus, and has a step of estimating the printing time of data composed by means of instructions of a computer language having a data attribute, and a step of transmitting the estimated printing time.

A data processing program of the present invention is a data processing program in a printing apparatus, and has a step of estimating the printing time of data composed by means of instructions of a computer language having a data attribute, and a step of transmitting the estimated printing time.

According to these, it is possible to ascertain the time necessary for printing by estimating the time necessary for printing on an object-by-object basis for content to be printed, and finding the sum total of the printing times for all objects to be printed.

A printing system of the present invention is a printing system that has a client device that receives data composed by means of instructions of a computer language having a data attribute, and a printing apparatus connected to the client device, wherein the printing apparatus has a section that receives data composed by means of instructions of a computer language having a data attribute from the client device, a printing time estimation section that estimates the printing time of received data, and a transmitting section that transmits an estimated printing time to the client device, and the client device has a section that receives a printing time transmitted from the printing apparatus, and a section that displays the received printing time on a screen.

According to this configuration, it is possible to ascertain the time necessary for printing by estimating the time necessary for printing on an object-by-object basis for content to be printed, and finding the sum total of the printing times for all objects to be printed.

A printing time estimation method of the present invention is a printing time estimation method in a printing system that has a client device that receives data composed by means of instructions of a computer language having a data attribute, and a printing apparatus connected to the client device, that printing time estimation method having a step whereby the printing apparatus receives data composed by means of instructions of a computer language having a data attribute from the client device, a step whereby the printing apparatus estimates the printing time of received data, a step whereby the printing apparatus transmits the estimated printing time to the client device, a step whereby the client device receives a printing time transmitted from the printing apparatus, and a step whereby the client device displays the received printing time on a screen.

According to this method, it is possible to ascertain the time necessary for printing by estimating the time necessary for printing on an object-by-object basis for content to be printed, and finding the sum total of the printing times for all objects to be printed.

A printing apparatus of the present invention employs a configuration that has a printing cost estimation section that estimates the printing cost of data composed by means of instructions of a computer language having a data attribute, and a transmitting section that transmits the estimated printing cost.

A printing apparatus of the present invention employs a configuration wherein, in the above-described configuration, the printing cost estimation section performs printing cost estimation by calculating the sum total of the printing paper cost and printing consumable cost based on a print style sheet that stipulates a print output format relating to data composed by means of instructions of a computer language having a data attribute, printing condition information, and the data composed by means of instructions of a computer language having a data attribute.

A printing apparatus of the present invention employs a configuration wherein, in the above-described configuration, the printing paper cost is calculated based on per-page printing paper cost information and information as to the number of print pages.

A printing apparatus of the present invention employs a configuration wherein, in the above-described configuration, the printing consumable cost is calculated by totalizing the font printing cost and image printing cost.

A printing apparatus of the present invention employs a configuration wherein, in the above-described configuration, the font printing cost is calculated based on font-unit printing cost information and information as to objects subject to font expansion.

A printing apparatus of the present invention employs a configuration wherein, in the above-described configuration, the image printing cost is calculated based on per-unit-area printing consumable cost information and print area size information.

According to these configurations, it is possible to ascertain the cost necessary for printing by making an estimate after referring to the contents and type of objects to be printed on a page-by-page basis in accordance with the contents of content to be printed.

A printing apparatus of the present invention employs a configuration wherein, in the above-described configuration, a style sheet storage section that stores a plurality of print style sheets is further provided, and the printing cost estimation section performs printing cost estimation by calculating the sum total of the printing paper cost and printing consumable cost based on a print style sheet selected from the plurality of print style sheets stored in the style sheet storage section, printing condition information, and the data composed by means of instructions of a computer language having a data attribute.

A printing apparatus of the present invention employs a configuration wherein, in the above-described configuration, an acquisition section that acquires a print style sheet and a style sheet storage section that stores an acquired style sheet are further provided, and the printing cost estimation section performs printing cost estimation by calculating the sum total of the printing paper cost and printing consumable cost based on a print style sheet stored in the style sheet storage section, printing condition information, and the data composed by means of instructions of a computer language having a data attribute.

According to these configurations, it is possible to increase the types of print style sheets used for printing as appropriate by acquiring print style sheets from an external source and transmitting information on print style sheets stored by a printing apparatus to a receiving apparatus.

A printing apparatus of the present invention employs a configuration wherein, in the above-described configuration, a default printing condition information storage section that stores default printing condition information, and a determining section that determines whether or not printing condition information has been conveyed, are further provided, and, when printing condition information has not been conveyed, the printing cost estimation section uses default printing condition information stored in the default printing condition information storage section as printing condition information to be used when estimating the printing cost.

According to this configuration, by preparing beforehand default print condition information, which is printing condition information that is used when print condition information has not been explicitly specified by a display apparatus, it is possible to estimate the printing cost even when print condition information is not specified.

A data processing method of the present invention is a data processing method in a printing apparatus, and has a step of estimating the printing cost of data composed by means of instructions of a computer language having a data attribute, and a step of transmitting the estimated printing cost.

According to this method, it is possible to ascertain the cost necessary for printing by making an estimate after referring to the contents and type of objects to be printed in accordance with the contents of content to be printed.

A data processing program of the present invention is a data processing program in a printing apparatus, and has a step of estimating the printing cost of data composed by means of instructions of a computer language having a data attribute, and a step of transmitting the estimated printing cost.

According to this program, it is possible to ascertain the cost necessary for printing by making an estimate after referring to the contents and type of objects to be printed in accordance with the contents of content to be printed.

A printing system of the present invention is a printing system that has a client device that receives data composed by means of instructions of a computer language having a data attribute, and a printing apparatus connected to the client device, wherein the printing apparatus has a section that receives data composed by means of instructions of a computer language having a data attribute from the client device, a printing cost estimation section that estimates the printing cost of received data, and a transmitting section that transmits an estimated printing cost to the client device, and the client device has a section that receives a printing cost transmitted from the printing apparatus, and a section that displays the received printing cost on a screen.

According to this configuration, it is possible to ascertain the cost necessary for printing by making an estimate after referring to the contents and type of objects to be printed in accordance with the contents of content to be printed.

A printing cost estimation method of the present invention is a printing cost estimation method in a printing system that has a client device that receives data composed by means of instructions of a computer language having a data attribute, and a printing apparatus connected to the client device, that printing cost estimation method having a step whereby the printing apparatus receives data composed by means of instructions of a computer language having a data attribute from the client device, a step whereby the printing apparatus estimates the printing cost of received data, a step whereby the printing apparatus transmits the estimated printing cost to the client device, a step whereby the client device receives a printing cost transmitted from the printing apparatus, and a step whereby the client device displays the received printing cost on a screen.

According to this method, it is possible to ascertain the cost necessary for printing by making an estimate after referring to the contents and type of objects to be printed in accordance with the contents of content to be printed.

A printing apparatus of the present invention employs a configuration that has a font storage section, a print image expansion section that generates print image data from print data for printing use based on a font in the font storage section, a printing section that prints the generated print image data, a preview data creation section that creates preview data for print preview use from print data for printing use based on a font in the font storage section, and a transmitting section that transmits created preview data.

According to this configuration, it is possible to confirm on the receiver side a preview a based on faithful character shapes using a font on the printing apparatus side. Also, according to this configuration, it is possible to confirm on the receiver side a preview with a layout faithful to print output based on a printing apparatus font.

A printing apparatus of the present invention has a font storage section, a print image expansion section that generates print image data from print data for printing use based on a font in the font storage section, a printing section that prints the generated print image data, a printing time estimation section that estimates the printing time based on the estimated expansion time of the font, and a transmitting section that transmits the estimated printing time to an external destination.

According to this configuration, it is possible to estimate more accurately the printing time according to a font on the printing apparatus side.

As is clear from the above descriptions, according to a printing apparatus and pre-printing information estimation method of the present invention, by converting print image data based on the display capability of a display apparatus, and creating preview data, it is possible to confirm a print image by means of a preview image in which print contents are adapted to the display capability of the display apparatus prior to printing from a printing apparatus, even if the display apparatus does not have preview image data creation capability.

Also, according to a printing apparatus and pre-printing information estimation method of the present invention, by calculating the number of pixels of preview data to be displayed from the display capability of a display apparatus and the number of print image pixels and by creating preview data based on that calculating number of pixels of preview data, it is possible to confirm a print image by means of a preview image in which print contents are adapted to the display capability of the display apparatus prior to printing from a printing apparatus, even if the display apparatus does not have preview image data creation capability.

Moreover, Because of not creating the printing image data which needs operation processing in which data size is large and great to generation when creating a preview data, It is unnecessary the work memory which expands and stores printing image data becomes in printing apparatus and processing which develops printing image data, thus enabling implement a lower-priced receiving apparatus.

Moreover, according to a printing apparatus and pre-printing information estimation method of the present invention, it is possible to ascertain the time necessary for printing by estimating the time necessary for printing on an object-by-object basis for content to be printed, and finding the sum total of the printing times for all objects to be printed.

Furthermore, according to a printing apparatus and pre-printing information estimation method of the present invention, it is possible to ascertain the cost necessary for printing by making an estimate after referring to the contents and type of objects to be printed in accordance with the contents of content to be printed.

The present invention is not limited to the above-described embodiments, and various variations and modifications may be possible without departing from the scope of the present invention.

This application is based on Japanese Patent Application No. 2001-153253 filed on May 22, 2001, entire contents of which are expressly incorporated by reference herein.

### INDUSTRIAL APPLICABILITY

The present invention is suitable for use in a printing apparatus connected a client apparatus which does not have a print preview image generate function.

What is claimed is:

1. A printing apparatus comprising:
a preview data creation section that creates preview data for print preview use from print data for printing use; and
a transmitting section that transmits created preview data.

2. The printing apparatus according to claim 1, wherein said preview data creation section creates preview data by converting a resolution of print data based on preview screen information and a number of print pixels.

3. The printing apparatus according to claim 2, wherein:
said preview screen information is a number of effective preview area pixels of a preview screen; and
said preview data creation section comprises:
a section that calculates said number of print pixels corresponding to one page of print data based on printing condition information including at least printing paper size, printing direction, and print resolution when printing print data;
a section that calculates a print data resolution conversion ratio, based on a number of effective preview area pixels of a preview screen and a calculated number of print pixels corresponding to one page of print data, so that a print image area corresponding to one page of print data fits into a preview area of a preview screen; and
a section that creates preview data by converting resolution of print data based on a calculated resolution conversion ratio.

4. The printing apparatus according to claim 3, wherein:
said preview screen information is composed of a number of horizontal pixels and a number of vertical pixels;
said number of print pixels is composed of a number of horizontal pixels and a number of vertical pixels; and
said resolution conversion ratio is calculated based on said preview screen information and a number of pixels in a direction for which conversion is more necessary of horizontal pixels and vertical pixels in said print pixels.

5. The printing apparatus according to claim 3, further comprising:
a default printing condition information storage section that stores default printing condition information; and
a determining section that determines whether or not printing condition information has been conveyed;
wherein said preview data creation section, when printing condition information has not been conveyed, uses default printing condition information stored by said default printing condition information storage section as printing condition information to be used when converting print data resolution.

6. The printing apparatus according to claim 1, further comprising:
a style sheet storage section that stores a print style sheet that stipulates a print output format relating to data composed by means of instructions of a computer language having a data attribute;
a receiving section that receives data composed by means of instructions of a computer language having a data attribute; and
a print data creation section that creates print data from received data based on a print style sheet stored in said style sheet storage section;
wherein said preview data creation section creates preview data for print preview use from created print data.

7. The printing apparatus according to claim 1, wherein said preview data creation section creates preview data for print preview use by performing rasterization processing of print data.

8. The printing apparatus according to claim 7, wherein said preview data creation section calculates a number of preview data pixels based on preview screen information and a number of print pixels, and creates preview data corresponding to said number of preview data pixels by performing rasterization processing of print data.

9. The printing apparatus according to claim 8, wherein:
said preview screen information is a number of effective preview area pixels of a preview screen; and
said preview data creation section comprises:
a section that calculates said number of print pixels corresponding to one page of print data based on printing condition information including at least printing paper size, printing direction, and print resolution when printing print data;
a section that calculates a resolution conversion ratio, based on a number of effective preview area pixels of a preview screen and a calculated number of print pixels corresponding to one page of print data, so that a print image area corresponding to one page of print data fits into said preview area of said preview screen; and
a section that calculates a number of preview data pixels from a calculated resolution conversion ratio and number of print pixels, and creates preview data by performing rasterization processing of print data based on a calculated number of preview data pixels.

10. The printing apparatus according to claim 9, wherein:
said preview screen information is composed of a number of horizontal pixels and a number of vertical pixels;
said number of print pixels is composed of a number of horizontal pixels and a number of vertical pixels; and
said resolution conversion ratio is calculated based on said preview screen information and a number of pixels in a direction for which conversion is more necessary of horizontal pixels and vertical pixels in said print pixels.

11. The printing apparatus according to claim 7, wherein said preview data creation section calculates a preview image display layout based on a number of preview data pixels to be displayed, and creates preview data by performing rasterization processing of print data based on said number of preview data pixels and said display layout.

12. The printing apparatus according to claim 7, wherein said preview data creation section calculates a print image layout based on a number of print image pixels, and creates preview data by performing rasterization processing of print data based on said number of preview data pixels and said print image layout.

13. The printing apparatus according to claim 7, wherein said print data is markup language format data written in a markup language that uses tags.

14. The printing apparatus according to claim 13, wherein said markup language format data is digital broadcasting content output from a digital broadcast receiver.

15. The printing apparatus according to claim 13, wherein said markup language format data is Internet content output from a mobile phone.

16. The printing apparatus according to claim 13, wherein said markup language format data is Internet content output from an Internet terminal.

17. The printing apparatus according to claim 6, wherein:
said style sheet storage section stores a plurality of print style sheets; and
said print data creation section creates print data from received data based on a print style sheet selected from a plurality of print style sheets stored in said style sheet storage section.

18. The printing apparatus according to claim 6, further comprising an acquisition section that acquires a print style sheet;
wherein said style sheet storage section stores an acquired print style sheet.

19. The printing apparatus according to claim 1, further comprising:
a print data storage section that stores print data used when creating preview data; and
a control section that causes print data stored in said print data storage section to be printed when a print directive is input after transmission of created preview data.

20. The printing apparatus according to claim 1, wherein:
said preview data creation section creates one page of preview data from one page of print data each time a preview directive is input; and
said transmitting section transmits created one page of preview data.

21. The printing apparatus according to claim 20, further comprising a determining section that determines presence or absence of a next page based on page information;
wherein said transmitting section transmits information on presence or absence of a next page together with created one page of preview data.

22. The printing apparatus according to claim 1, wherein:
said preview data creation section creates all pages of preview data from print data; and
said transmitting section transmits one page of preview data sequentially from created all pages of preview data each time a preview directive is input.

23. The printing apparatus according to claim 22, further comprising a detecting section that detects a total number of pages of created preview data;
wherein said transmitting section, when transmitting a first page of preview data, transmits information as to a detected total number of pages together with that first page of preview data.

24. The printing apparatus according to claim 22, further comprising:
a detecting section that detects a total number of pages of created preview data; and
a counting section that calculates a remaining number of untransmitted pages by subtracting a number of transmitted pages from a detected total number of pages;
wherein said transmitting section, when transmitting one page of preview data, transmits acquired information as to a remaining number of pages together with that one page of preview data.

25. The printing apparatus according to claim 1, further comprising a calculating section that calculates a number of pages that can be displayed on a preview screen at one time based on preview screen information and printing condition information;
wherein:
said preview data creation section creates that displayable number of pages of preview data from a calculated displayable number of pages of print data; and
said transmitting section simultaneously transmits a created displayable number of pages of preview data.

26. The printing apparatus according to claim 25, further comprising:
a style sheet storage section that stores a print style sheet that stipulates a print output format relating to data composed by means of instructions of a computer language having a data attribute;
a receiving section that receives data composed by means of instructions of a computer language having a data attribute; and
a print data creation section that creates a calculated displayable number of pages of print data from received data based on a print style sheet stored in said style sheet storage section.

27. A data processing method in a printing apparatus, said data processing method comprising:
a step of creating preview data for print preview use from print data for printing use; and
a step of transmitting created preview data.

28. A computer-readable medium that contains control directives of a computer device that executes the data processing method according to claim 27.

29. A printing system comprising:
a client device that receives data composed by means of instructions of a computer language having a data attribute; and
a printing apparatus connected to said client device;
wherein:
said printing apparatus has:
a section that stores a print style sheet that stipulates a print output format relating to data composed by means of instructions of a computer language having a data attribute;
a section that receives data composed by means of instructions of a computer language having a data attribute from said client device;
a section that creates print data for printing use from received data based on a print style sheet stored in that printing apparatus;
a section that creates preview data for print preview use by converting resolution of created print data based on preview screen information and printing condition information; and
a section that transmits created preview data to said client device; and
said client device has:
a section that receives preview data transmitted from said printing apparatus; and
a section that displays received preview data on a screen.

30. A print preview method in a printing system having:
a client device that receives data composed by means of instructions of a computer language having a data attribute; and
a printing apparatus connected to said client device;
said print preview method comprising:
a step whereby said printing apparatus receives data composed by means of instructions of a computer language having a data attribute from the client device;
a step whereby said printing apparatus creates print data for printing use from received data based on a print style sheet that stipulates a print output format relating to data composed by means of instructions of a computer language having a data attribute stored in that printing apparatus;
a step whereby said printing apparatus creates preview data for print preview use by converting resolution of created print data based on preview screen information and printing condition information;
a step whereby said printing apparatus transmits created preview data to said client device;
a step whereby said client device receives preview data transmitted from said printing apparatus; and
a step whereby said client device displays received preview data on a screen.

31. A printing apparatus comprising:
a printing time estimation section that estimates printing time of data composed by means of instructions of a computer language having a data attribute; and
a transmitting section that transmits an estimated printing time.

32. The printing apparatus according to claim 31, wherein said printing time estimation section calculates at least one time from among font expansion time, image expansion time, and engine processing time, and estimates printing time by totalizing calculated times.

33. The printing apparatus according to claim 32, wherein said font expansion time is calculated based on font expansion speed information for that printing apparatus.

34. The printing apparatus according to claim 32, wherein said font expansion time is calculated by multiplying a font expansion speed of that printing apparatus by a total number of characters subject to font expansion contained in said data.

35. The printing apparatus according to claim 32, wherein said image expansion time is calculated based on image expansion speed information for that printing apparatus.

36. The printing apparatus according to claim 32, wherein said image expansion time is calculated by multiplying an image expansion speed of that printing apparatus by a size of a total area subject to image expansion contained in said data.

37. The printing apparatus according to claim 32, wherein said engine processing time is calculated based on engine performance information for that printing apparatus, a print style sheet that stipulates a print output format relating to data composed by means of instructions of a computer language having a data attribute, and said data composed by means of instructions of a computer language having a data attribute.

38. The printing apparatus according to claim 37, wherein said engine performance information is selected based on printing condition information including at least printing paper size, printing direction, and print resolution when printing print data.

39. The printing apparatus according to claim 32, wherein, when printing is performed while moving a print-head, said engine processing time is calculated based on a print area box calculated based on a print style sheet, and head movement speed and paper feed speed of that printing apparatus.

40. The printing apparatus according to claim 32, wherein:
when printing is performed while moving a print-head, a path of movement of said print-head is calculated based on printing condition information including at least printing paper size, printing direction, and print resolution when printing print data; and
said engine processing time is calculated based on an obtained path of movement and head movement speed of that printing apparatus.

41. A printing apparatus according to claim 32, wherein, when printing is performed on a page-by-page basis, said engine processing time is calculated based on a total number of pages calculated based on a print style sheet, and printing time per page of that printing apparatus.

42. The printing apparatus according to claim 37, further comprising a style sheet storage section that stores a plurality of print style sheets;
wherein said printing time estimation section, when calculating engine processing time, performs engine processing time calculation based on engine performance information for that printing apparatus, a print style sheet selected from a plurality of print style sheets stored in said style sheet storage section, and said data composed by means of instructions of a computer language having a data attribute.

43. The printing apparatus according to claim 37, further comprising:
an acquisition section that acquires a print style sheet; and
a style sheet storage section that stores an acquired style sheet;
wherein said printing time estimation section, when calculating engine processing time, performs engine processing time calculation based on engine performance information for that printing apparatus, a print style sheet stored in said style sheet storage section, and said data composed by means of instructions of a computer language having a data attribute.

44. The printing apparatus according to claim 32, wherein said engine processing time is a set value.

45. The printing apparatus according to claim 38, further comprising:
a default printing condition information storage section that stores default printing condition information; and
a determining section that determines whether or not printing condition information has been conveyed;
wherein, when printing condition information has not been conveyed, said printing time estimation section uses default printing condition information stored in said default printing condition information storage section as printing condition information to be used when estimating printing time.

46. A data processing method in a printing apparatus, said data processing method comprising:
a step of estimating printing time of data composed by means of instructions of a computer language having a data attribute; and
a step of transmitting an estimated printing time.

47. A computer-readable medium that contains control directives of a computer device that executes the data processing method according to claim 46.

48. A printing system comprising:
a client device that receives data composed by means of instructions of a computer language having a data attribute; and
a printing apparatus connected to said client device;
wherein:
said printing apparatus has:
a section that receives data composed by means of instructions of a computer language having a data attribute from said client device;
a printing time estimation section that estimates printing time of received data; and
a transmitting section that transmits an estimated printing time to said client device; and
said client device has:
a section that receives a printing time transmitted from said printing apparatus; and
a section that displays a received printing time on a screen.

49. A printing time estimation method in a printing system that has:
a client device that receives data composed by means of instructions of a computer language having a data attribute; and
a printing apparatus connected to said client device;
said printing time estimation method comprising:
a step whereby said printing apparatus receives data composed by means of instructions of a computer language having a data attribute from said client device;
a step whereby said printing apparatus estimates printing time of received data;
a step whereby said printing apparatus transmits an estimated printing time to said client device;
a step whereby said client device receives a printing time transmitted from said printing apparatus; and
a step whereby said client device displays a received printing time on a screen.

50. A printing apparatus comprising:
a printing cost estimation section that estimates a printing cost of data composed by means of instructions of a computer language having a data attribute; and
a transmitting section that transmits an estimated printing cost.

51. The printing apparatus according to claim 50, wherein said printing cost estimation section performs printing cost estimation by calculating a sum total of printing paper cost and printing consumable cost based on a print style sheet that stipulates a print output format relating to data composed by means of instructions of a computer language having a data attribute, printing condition information, and said data composed by means of instructions of a computer language having a data attribute.

52. The printing apparatus according to claim 51, wherein said printing paper cost is calculated based on per-page printing paper cost information and information as to a number of print pages.

53. The printing apparatus according to claim 51, wherein said printing consumable cost is calculated by totalizing font printing cost and image printing cost.

54. The printing apparatus according to claim 53, wherein said font printing cost is calculated based on font-unit printing cost information and information as to objects subject to font expansion.

55. The printing apparatus according to claim 53, wherein said image printing cost is calculated based on per-unit-area printing consumable cost information and print area size information.

56. The printing apparatus according to claim 51, further comprising a style sheet storage section that stores a plurality of print style sheets;
wherein said printing cost estimation section performs printing cost estimation by calculating a sum total of printing paper cost and printing consumable cost based on a print style sheet selected from among a plurality of print style sheets stored in said style sheet storage section, printing condition information, and said data composed by means of instructions of a computer language having a data attribute.

57. The printing apparatus according to claim 51, further comprising:
an acquisition section that acquires a print style sheet; and
a style sheet storage section that stores an acquired style sheet;
wherein said printing cost estimation section performs printing cost estimation by calculating a sum total of printing paper cost and printing consumable cost based on a print style sheet stored in said style sheet storage section, printing condition information, and said data composed by means of instructions of a computer language having a data attribute.

58. The printing apparatus according to claim 51, further comprising:
a default printing condition information storage section that stores default printing condition information; and
a determining section that determines whether or not printing condition information has been conveyed;
wherein, when printing condition information has not been conveyed, said printing cost estimation section uses default printing condition information stored in said default printing condition information storage section as printing condition information to be used when estimating printing cost.

59. A data processing method in a printing apparatus, said data processing method comprising:
a step of estimating a printing cost of data composed by means of instructions of a computer language having a data attribute; and
a step of transmitting an estimated printing cost.

60. A computer-readable medium that contains control directives of a computer device that executes the data processing method according to claim 59.

61. A printing system comprising:
a client device that receives data composed by means of instructions of a computer language having a data attribute; and
a printing apparatus connected to said client device;
wherein:
said printing apparatus has:
a section that receives data composed by means of instructions of a computer language having a data attribute from the client device;
a printing cost estimation section that estimates a printing cost of received data; and
a transmitting section that transmits an estimated printing cost to said client device; and
said client device has:
a section that receives a printing cost transmitted from said printing apparatus; and
a section that displays a received printing cost on a screen.

62. A printing cost estimation method in a printing system that has:
a client device that receives data composed by means of instructions of a computer language having a data attribute; and
a printing apparatus connected to said client device;
said printing cost estimation method comprising:
a step whereby said printing apparatus receives data composed by means of instructions of a computer language having a data attribute from the client device;
a step whereby said printing apparatus estimates a printing cost of received data;
a step whereby said printing apparatus transmits an estimated printing cost to said client device;
a step whereby said client device receives a printing cost transmitted from said printing apparatus; and
a step whereby said client device displays a received printing cost on a screen.
